(19) United States
(12) Patent Application Publication
(10) Pub. No.: US 2025/0202643 A1
(43) Pub. Date: Jun. 19, 2025

(54) CHANNEL STATE INFORMATION HYPOTHESES CONFIGURATION FOR COHERENT JOINT TRANSMISSION SCENARIOS

(71) Applicant: QUALCOMM Incorporated, San Diego, CA (US)

(72) Inventors: Jing DAI, Beijing (CN); Chao WEI, Beijing (CN); Yi HUANG, San Diego, CA (US); Chenxi HAO, Beijing (CN); Liangming WU, Beijing (CN); Wei XI, Beijing (CN)

(21) Appl. No.: 18/848,708

(22) PCT Filed: May 10, 2022
(86) PCT No.: PCT/CN2022/091856

§ 371 Date: Sep. 19, 2024

(51) Int. Cl. H04L 5/00; H04W 72/541

(52) U.S. Cl. CPC H04L 5/0048; H04L 5/0035; H04L 5/0053; H04W 72/541

(57) ABSTRACT

Various aspects of the present disclosure generally relate to wireless communication. In some aspects, a user equipment (UE) may receive, from a network entity, configuration information indicating a set of channel state information (CSI) hypotheses associated with coherent joint transmission (CJT) CSI estimations. The UE may transmit, to the network entity, a ((CSI) report indicating one or more (CSI) reference signal (CSI-RS) resource indicators (CRIs) associated with one or more (CSI) hypotheses of the set of (CSI) hypotheses, wherein each CRI of the one or more CRIs is associated with a respective CSI hypothesis from the one or more (CSI) hypotheses. Numerous other aspects are described.

### FIELD OF THE DISCLOSURE

Aspects of the present disclosure generally relate to wireless communication and to techniques and apparatuses for a channel state information (CSI) hypotheses configuration for coherent joint transmission (CJT) scenarios.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network entities that support communication for wireless communication devices, such as a user equipment (UE) or multiple UEs. A UE may communicate with a network entity via downlink communications and uplink communications. “Downlink” (or “DL”) refers to a communication link from the network entity to the UE, and “uplink” (or “UL”) refers to a communication link from the UE to the network entity.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network entity, configuration information indicating a set of channel state information (CSI) hypotheses associated with coherent joint transmission (CJT) CSI estimations. The one or more processors may be configured to transmit, to the network entity, a CSI report indicating one or more CSI reference signal (CSI-RS) resource indicators (CRIs) associated with one or more CSI hypotheses of the set of CSI hypotheses, wherein each CRI of the one or more CRIs is associated with a respective CSI hypothesis from the one or more CSI hypotheses.

Some aspects described herein relate to a network entity for wireless communication. The network entity may include a memory and one or more processors coupled to the memory. The one or more processors may be configured to transmit configuration information intended for a UE indicating a set of CSI hypotheses associated with CJT CSI estimations. The one or more processors may be configured to receive a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses.

Some aspects described herein relate to a method of wireless communication performed by a UE. The method may include receiving, from a network entity, configuration information indicating a set of CSI hypotheses associated with CJT CSI estimations. The method may include transmitting, to the network entity, a CSI report indicating one or more CRIs associated with one or more CSI hypotheses of the set of CSI hypotheses, wherein each CRI of the one or more CRIs is associated with a respective CSI hypothesis from the one or more CSI hypotheses.

Some aspects described herein relate to a method of wireless communication performed by a network entity. The method may include transmitting configuration information intended for a UE indicating a set of CSI hypotheses associated with CJT CSI estimations. The method may include receiving a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses.

Some aspects described herein relate to a non-transitory computer-readable medium that stores a set of instructions for wireless communication by a UE. The set of instructions, when executed by one or more processors of the UE, may cause the UE to receive, from a network entity, configuration information indicating a set of CSI hypotheses associated with CJT CSI estimations. The set of instructions, when executed by one or more processors of the UE, may cause the UE to transmit, to the network entity, a CSI report indicating one or more CRIs associated with one or more CSI hypotheses of the set of CSI hypotheses, wherein each CRI of the one or more CRIs is associated with a respective CSI hypothesis from the one or more CSI hypotheses.

Some aspects described herein relate to a non-transitory computer-readable medium that stores a set of instructions for wireless communication by a network entity. The set of instructions, when executed by one or more processors of the network entity, may cause the network entity to transmit configuration information intended for a UE indicating a set of CSI hypotheses associated with CJT CSI estimations. The set of instructions, when executed by one or more processors of the network entity, may cause the network entity to receive a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses.

Some aspects described herein relate to an apparatus for wireless communication. The apparatus may include means for receiving, from a network entity, configuration information indicating a set of CSI hypotheses associated with CJT CSI estimations. The apparatus may include means for transmitting, to the network entity, a CSI report indicating one or more CRIs associated with one or more CSI hypotheses of the set of CSI hypotheses, wherein each CRI of the one or more CRIs is associated with a respective CSI hypothesis from the one or more CSI hypotheses.

Some aspects described herein relate to an apparatus for wireless communication. The apparatus may include means for transmitting configuration information intended for a UE indicating a set of CSI hypotheses associated with CJT CSI estimations. The apparatus may include means for receiving a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of multiple transmission reception point (TRP) communication, in accordance with the present disclosure.

FIG. 6 is a diagram illustrating an example of coherent joint transmission (CJT) and non-coherent joint transmission (NCJT) for multiple TRP (multi-TRP) communication, in accordance with the present disclosure.

FIG. 7 is a diagram illustrating an example of a channel state information (CSI) hypothesis configuration for non-coherent joint transmission for multi-TRP communication, in accordance with the present disclosure.

FIG. 8 is a diagram of an example associated with a CSI hypotheses configuration for CJT scenarios, in accordance with the present disclosure.

FIG. 9 is a diagram of an example associated with a CSI reference signal (CSI-RS) resource based CSI hypotheses configuration for CJT scenarios, in accordance with the present disclosure.

FIG. 10 is a diagram of an example associated with a CSI-RS resource based CSI hypotheses configuration for CJT scenarios, in accordance with the present disclosure.

FIG. 11 is a diagram of an example associated with a port group based CSI hypotheses configuration for CJT scenarios, in accordance with the present disclosure.

FIG. 12 is a diagram of an example associated with a port group based CSI hypotheses configuration for CJT scenarios, in accordance with the present disclosure.

FIG. 13 is a diagram of an example associated with a CSI-RS resource based CSI hypotheses configuration for both CJT scenarios and NCJT scenarios, in accordance with the present disclosure.

FIG. 14 is a diagram of an example associated with a port group based CSI hypotheses configuration for both CJT scenarios and NCJT scenarios, in accordance with the present disclosure.

FIG. 15 is a diagram illustrating an example process performed, for example, by a UE, in accordance with the present disclosure.

FIG. 16 is a diagram illustrating an example process performed, for example, by a network entity, in accordance with the present disclosure.

FIG. 17 is a diagram of an example apparatus for wireless communication, in accordance with the present disclosure.

FIG. 18 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

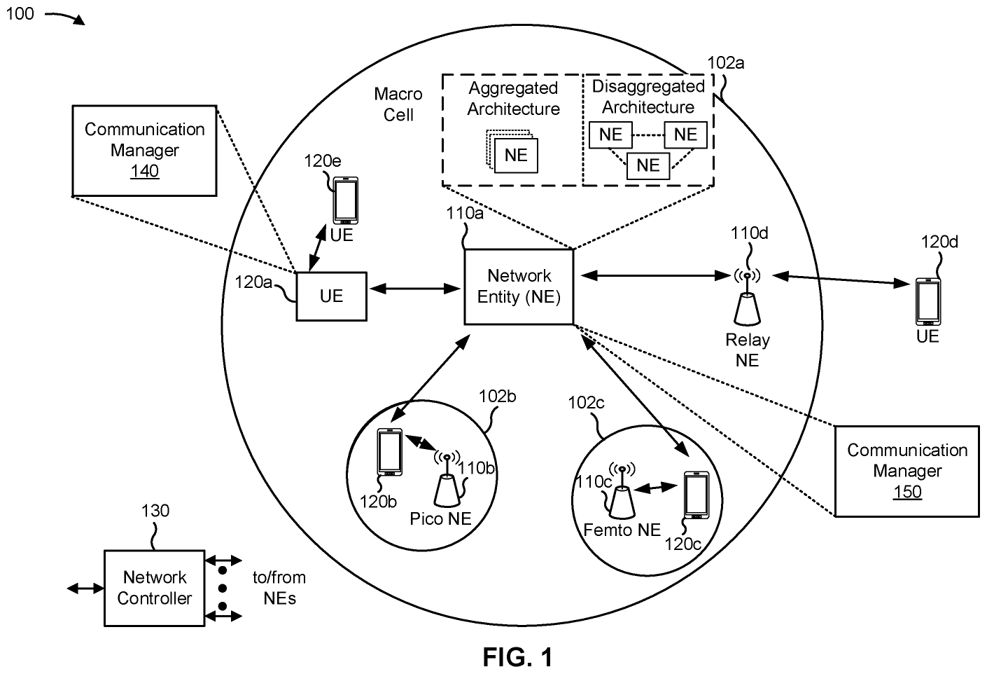

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network entities 110 (shown as a network entity (NE) 110a, an NE 110b, an NE 110c, and an NE 110d), a user equipment (UE) 120 or multiple UEs 120 (shown as a UE 120a, a UE 120b, a UE 120c, a UE 120d, and a UE 120e), and/or other network entities. A network entity 110 is an entity that communicates with UEs 120. As shown, a network entity 110 may include one or more network entities. For example, a network entity 110 may be an aggregated network entity, meaning that the aggregated network node is configured to utilize a radio protocol stack that is physically or logically integrated within a single RAN node (for example, within a single device or unit). As another example, a network entity 110 may be a disaggregated network node (sometimes referred to as a disaggregated base station), meaning that the network entity 110 includes two or more non-co-located network nodes. A disaggregated network entity may be configured to utilize a protocol stack that is physically or logically distributed among two or more nodes (such as one or more central units (CUs), one or more distributed units (DUs), or one or more radio units (RUS)).

In some examples, a network entity 110 includes an entity that communicates with UEs 120 via a radio access link, such as an RU. In some examples, a network entity 110 includes an entity that communicates with other network entities 110 via a fronthaul link or a midhaul link, such as a DU. In some examples, a network entity 110 includes an entity that communicates with other network entities 110 via a midhaul link or a core network via a backhaul link, such as a CU. In some examples, a network entity 110 (such as an aggregated network entity 110 or a disaggregated network entity 110) may include multiple network entities, such as one or more RUs, one or more CUS, or one or more DUs. A network entity 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network entities 110 may be interconnected to one another or to one or more other network entities 110 in the wireless network 100 through various types of fronthaul, midhaul, or backhaul interfaces, such as a direct physical connection, an air interface, or a virtual network, using any suitable transport network. Each network entity 110 may provide communication coverage for a particular geographic area. In the Third Generation Partnership Project (3GPP), the term “cell” can refer to a coverage area of a network entity 110 and/or a network entity subsystem serving this coverage area, depending on the context in which the term is used.

A network entity 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A network entity 110 for a macro cell may be referred to as a macro network entity. A network entity 110 for a pico cell may be referred to as a pico network entity. A network entity 110 for a femto cell may be referred to as a femto network entity or an in-home network entity. In the example shown in FIG. 1, the network entity 110a may be a macro network entity for a macro cell 102a, the network entity 110b may be a pico network entity for a pico cell 102b, and the network entity 110c may be a femto network entity for a femto cell 102c. A network entity 110 may support one or multiple (e.g., three) cells. In some examples, a cell may not necessarily be stationary, and the geographic area of the cell may move according to the location of a network entity 110 that is mobile (for example, a mobile network entity).

In some aspects, the term “base station” or “network entity” may refer to an aggregated base station, a disaggregated base station, an integrated access and backhaul (IAB) node, a relay node, or one or more components thereof. For example, in some aspects, “base station” or “network entity” may refer to a CU, a DU, an RU, a Near-Real Time (Near-RT) radio-access network (RAN) Intelligent Controller (RIC), or a Non-Real Time (Non-RT) RIC, or a combination thereof. In some aspects, the term “base station” or “network entity” may refer to one device configured to perform one or more functions, such as those described herein in connection with the network entity 110. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a network entity 110 that is mobile (e.g., a mobile network entity). In some examples, the network entities 110 may be interconnected to one another and/or to one or more other network entities 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a network entity 110 or a UE 120) and send a transmission of the data to a downstream station (e.g., a UE 120 or a network entity 110). A relay station may be a UE 120 that can relay transmissions for other UEs 120. In the example shown in FIG. 1, the network entity 110d (e.g., a relay network entity) may communicate with the network entity 110a (e.g., a macro network entity) and the UE 120d in order to facilitate communication between the network entity 110a and the UE 120d. A network entity 110 that relays communications may be referred to as a relay station, a relay base station, a relay, a relay network entity, and/or a relay node, among other examples.

The wireless network 100 may be a heterogeneous network that includes network entities 110 of different types, such as macro network entities, pico network entities, femto network entities, relay network entities, or the like. These different types of network entities 110 may have different transmit power levels, different coverage areas, and/or different impacts on interference in the wireless network 100. For example, macro network entities may have a high transmit power level (e.g., 5 to 40 watts) whereas pico network entities, femto network entities, and relay network entities may have lower transmit power levels (e.g., 0.1 to 2 watts).

A network controller 130 may couple to or communicate with a set of network entities 110 and may provide coordination and control for these network entities 110. The network controller 130 may communicate with the network entities 110 via a backhaul communication link. The network entities 110 may communicate with one another directly or indirectly via a wireless or wireline backhaul communication link. In some aspects, the network controller 130 may be a CU, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network entity, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network entity 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network entity, configuration information indicating a set of channel state information (CSI) hypotheses associated with coherent joint transmission (CJT) CSI estimations; and transmit, to the network entity, a CSI report indicating one or more CSI reference signal (CSI-RS) resource indicators (CRIs) associated with one or more CSI hypotheses of the set of CSI hypotheses, wherein each CRI of the one or more CRIs is associated with a respective CSI hypothesis from the one or more CSI hypotheses. Additionally, or alternatively, the communication manager 140 may perform one or more other operations described herein.

In some aspects, the network entity 110 may include a communication manager 150. As described in more detail elsewhere herein, the communication manager 150 may transmit configuration information intended for a UE indicating a set of CSI hypotheses associated with CJT CSI estimations; and receive a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses. Additionally, or alternatively, the communication manager 150 may perform one or more other operations described herein.

As indicated above, FIG. 1 is provided as an example. Other examples may differ from what is described with regard to FIG. 1.

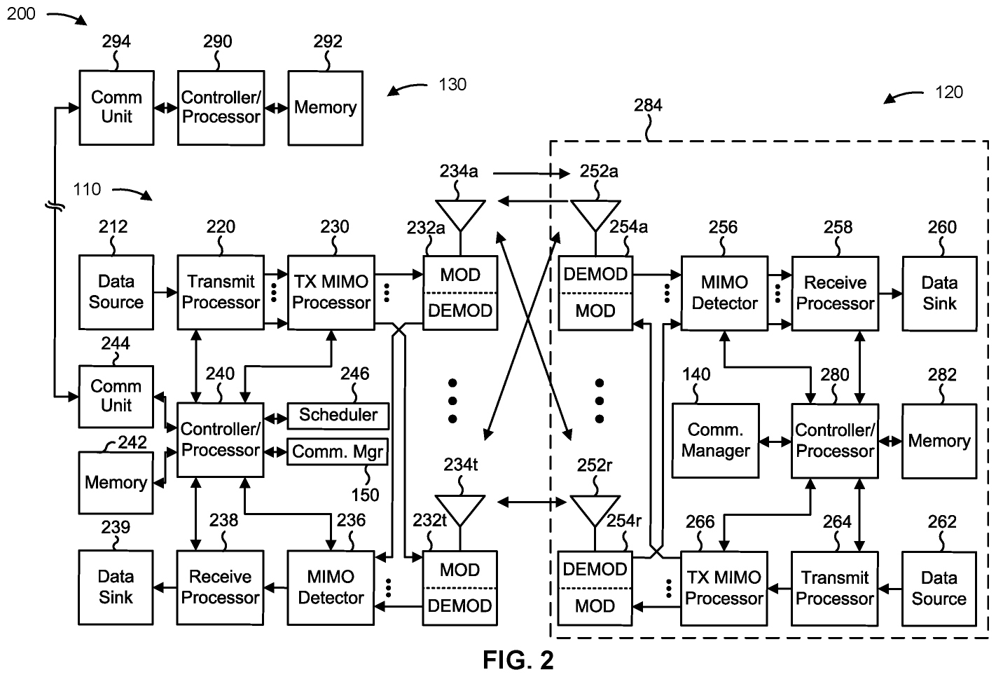

FIG. 2 is a diagram illustrating an example 200 of a network entity 110 in communication with a UE 120 in the wireless network 100, in accordance with the present disclosure. The network entity 110 may be equipped with a set of antennas 234a through 234t, such as T antennas (T≥1). The UE 120 may be equipped with a set of antennas 252a through 252r, such as R antennas (R≥1). The network entity 110 of example 200 includes one or more radio frequency components, such as antennas 234 and a modem 254. In some examples, a network entity 110 may include an interface, a communication component, or another component that facilitates communication with the UE 120 or another network entity. Some network entities 110 (such as one or more CUs or one or more DUs) may not include radio frequency components that facilitate direct communication with the UE 120.

At the network entity 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network entity 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network entity 110 and/or other network entities 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

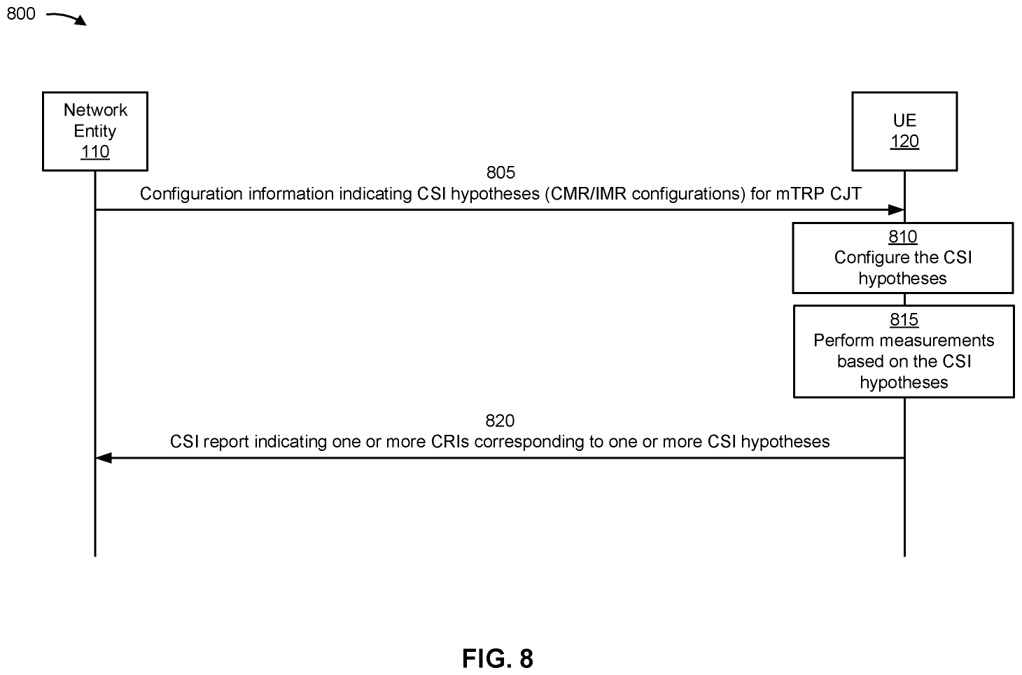

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-18).

At the network entity 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity 110 may include a communication unit 244 and may communicate with the network controller 130 via the communication unit 244. The network entity 110 may include a scheduler 246 to schedule one or more UEs 120 for downlink and/or uplink communications. In some examples, the modem 232 of the network entity 110 may include a modulator and a demodulator. In some examples, the network entity 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-18).

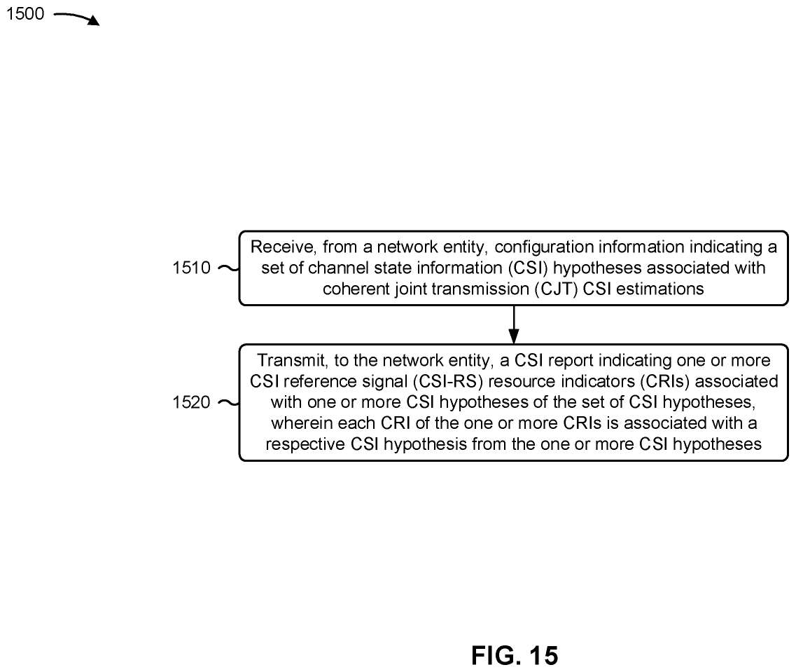

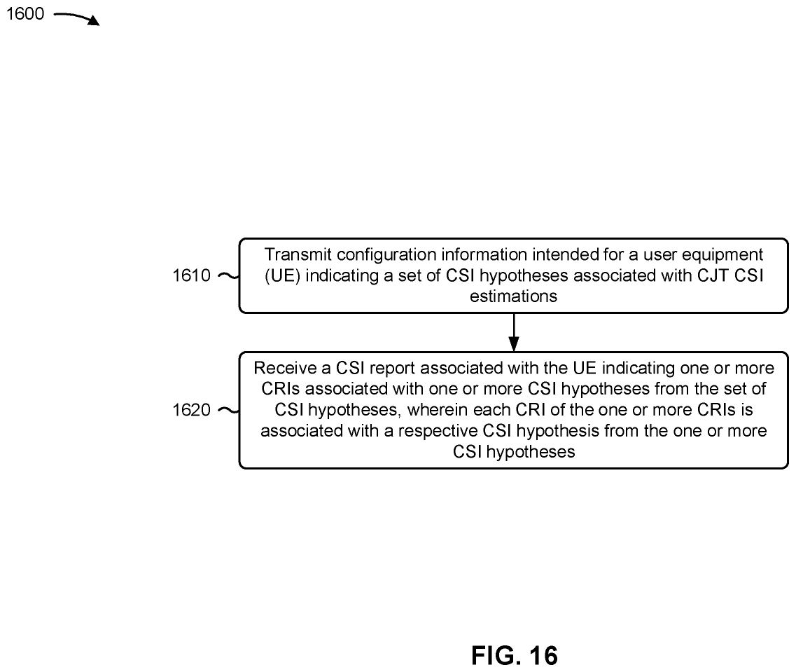

The controller/processor 240 of the network entity 110, the controller/processor 280 of the UE 120, and/or any other component(s) of FIG. 2 may perform one or more techniques associated with a CSI hypotheses configuration for CJT scenarios, as described in more detail elsewhere herein. For example, the controller/processor 240 of the network entity 110, the controller/processor 280 of the UE 120, and/or any other component(s) of FIG. 2 may perform or direct operations of, for example, process 1500 of FIG. 15, process 1600 of FIG. 16, process and/or other processes as described herein. The memory 242 and the memory 282 may store data and program codes for the network entity 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity 110 and/or the UE 120, may cause the one or more processors, the UE 120, and/or the network entity 110 to perform or direct operations of, for example, process 1500 of FIG. 15, process 1600 of FIG. 16, process and/or other processes as described herein. In some examples, executing instructions may include running the instructions, converting the instructions, compiling the instructions, and/or interpreting the instructions, among other examples.

In some aspects, the UE 120 includes means for receiving, from a network entity, configuration information indicating a set of CSI hypotheses associated with CJT CSI estimations (e.g., using antenna 252, modem 254, MIMO detector 256, receive processor 258, controller/processor 280, and/or memory 282); and/or means for transmitting, to the network entity, a CSI report indicating one or more CRIs associated with one or more CSI hypotheses of the set of CSI hypotheses, wherein each CRI of the one or more CRIs is associated with a respective CSI hypothesis from the one or more CSI hypotheses (e.g., using controller/processor 280, transmit processor 264, TX MIMO processor 266, modem 254, antenna 252, and/or memory 282). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity 110 includes means for transmitting configuration information intended for a UE indicating a set of CSI hypotheses associated with CJT CSI estimations (e.g., using controller/processor 240, transmit processor 220, TX MIMO processor 230, modem 232, antenna 234, and/or memory 242); and/or means for receiving a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses (e.g., using antenna 234, modem 232, MIMO detector 236, receive processor 238, controller/processor 240, and/or memory 242). In some aspects, the means for the network entity 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

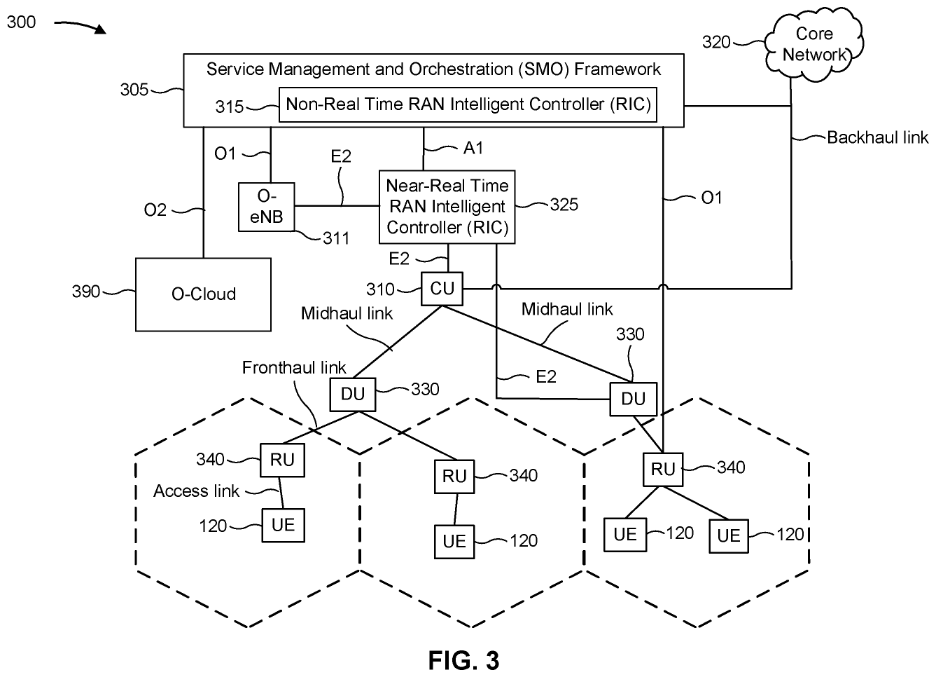

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

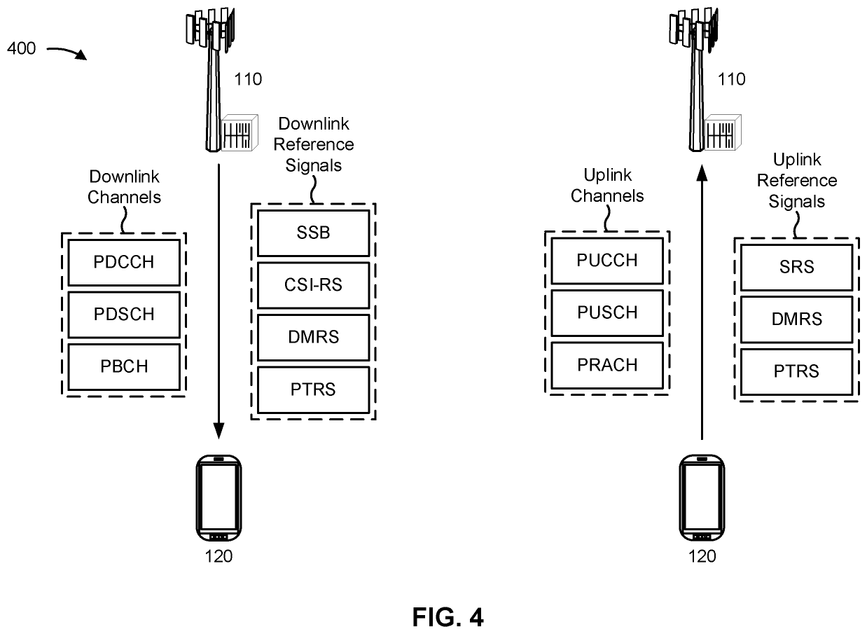

FIG. 4 is a diagram illustrating an example 400 of physical channels and reference signals in a wireless network, in accordance with the present disclosure. As shown in FIG. 4, downlink channels and downlink reference signals may carry information from a network entity 110 to a UE 120, and uplink channels and uplink reference signals may carry information from a UE 120 to a network entity 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network entity 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network entity 110 may configure a set of CSI-RSs for the UE 120, and the UE 120 may measure the configured set of CSI-RSs. Based at least in part on the measurements, the UE 120 may perform channel estimation and may report channel estimation parameters to the network entity 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network entity 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network entity 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network entities in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network entity 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network entity 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network entity 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

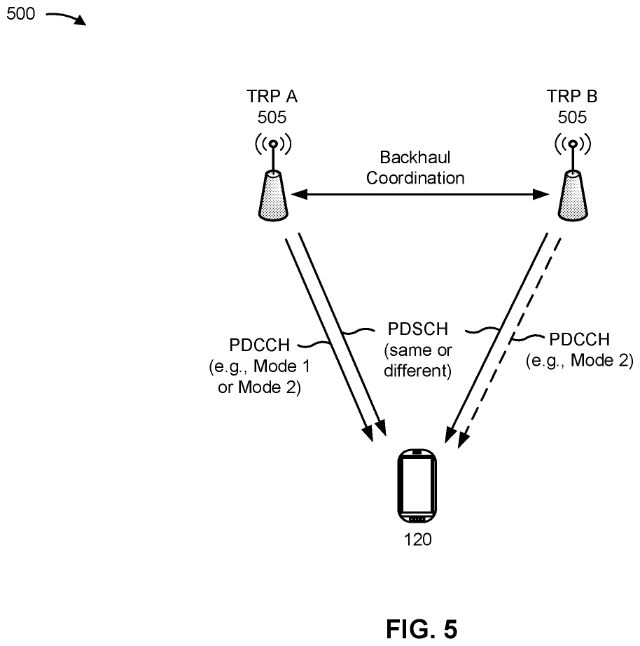

FIG. 5 is a diagram illustrating an example 500 of multi-TRP communication, in accordance with the present disclosure. Multi-TRP communication may sometimes referred to as multi-panel communication. As shown in FIG. 5, multiple TRPs 505 may communicate with the same UE 120.

A TRP 505 may be a DU or an RU of a distributed RAN. In some aspects, a TRP 505 may correspond to a network entity 110 described above in connection with FIG. 1. For example, different TRPs 505 may be included in different network entities 110. Additionally, or alternatively, multiple TRPs 505 may be included in a single network entity 110. In some aspects, a network entity 110 may include a CU and/or one or more DUs or RUs (e.g., one or more TRPs 505). In some cases, a TRP 505 may be referred to as a cell, a panel, an antenna array, or an array. Therefore, as used herein, “TRP” may refer to a network entity, a DU, an RU, a cell, an antenna panel, an antenna array, and/or an array, among other examples. A TRP 505 may be connected to a single access node controller (e.g., a single CU or a single DU) or to multiple access node controllers (e.g., multiple CUs or DUs). In some aspects, a PDCP layer, an RLC layer, and/or a MAC layer may be configured to terminate at a CU, at a DU, or at a TRP 505.

In some aspects, multiple TRPs 505 may transmit communications (e.g., the same communication or different communications) in the same transmission time interval (TTI) (e.g., a slot, a mini-slot, a subframe, or a symbol) or different TTIs using different quasi-colocation (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 505 may be configured to individually (e.g., using dynamic selection) or jointly (e.g., using joint transmission with one or more other TRPs 505) serve traffic to a UE 120.

The multiple TRPs 505 (shown as TRP A and TRP B) may communicate with the same UE 120 in a coordinated manner (e.g., using coordinated multipoint transmissions) to improve reliability and/or increase throughput. Although two TRPs are shown in FIG. 5, the UE 120 may communicate with more than two TRPs (such as four TRPs) in a similar manner as described herein. The TRPs 505 may coordinate such communications via an interface between the TRPs 505 (e.g., a backhaul interface and/or an access node controller or a CU). The interface may have a smaller delay and/or higher capacity when the TRPs 505 are co-located at the same network entity 110 (e.g., when the TRPs 505 are different antenna arrays or panels of the same network entity 110), and may have a larger delay and/or lower capacity (as compared to colocation) when the TRPs 505 are located at different network entities 110. The different TRPs 505 may communicate with the UE 120 using different QCL relationships (e.g., different TCI states), DMRS ports, and/or different layers (e.g., of a multi-layer communication).

In a first multi-TRP transmission mode (e.g., Mode 1), a single PDCCH may be used to schedule downlink data communications for a single PDSCH. In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

In some cases, multi-TRP scenarios may be associated with two TRPs (e.g., as depicted in FIG. 5). For example, a wireless communication standard may define, or otherwise fix, that multi-TRP scenarios may be associated with two TRPs (e.g., Release 17 or earlier Releases of 3GPP Technical Specifications may define configurations or operations assuming that the quantity of TRPs is limited to, or fixed at, two TRPs). However, in future deployments, the quantity of TRPs in a multi-TRP scenario may be greater than two, such as three TRPs, four TRPs, or more TRPs.

As indicated above, FIG. 5 is provided as an example. Other examples may differ from what is described with respect to FIG. 5.

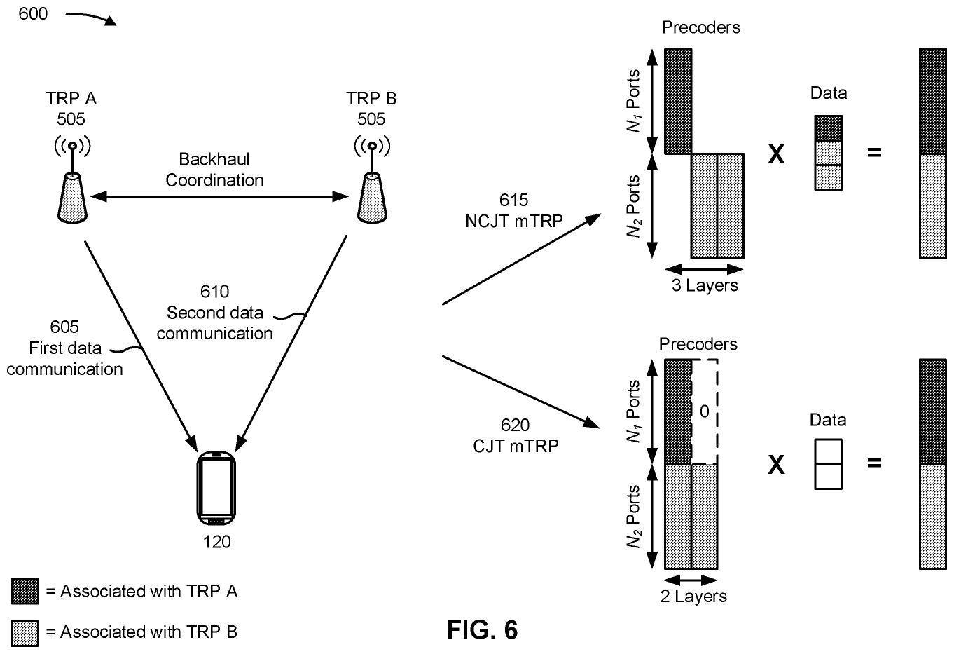

FIG. 6 is a diagram illustrating an example 600 of coherent joint transmission and non-coherent joint transmission for multi-TRP communication, in accordance with the present disclosure. As shown in FIG. 6, the TRPs 505 (TRP A and TRP B) may communicate with the same UE 120 in a coordinated manner (e.g., using coordinated multipoint transmissions) to improve reliability and/or increase throughput, in a similar manner as described in connection with FIG. 5. For example, as shown in FIG. 6, the TRP A may transmit a first data communication 605 to the UE 120. The TRP B may transmit a second data communication 610 to the UE 120. The first data communication 605 and the second data communication 610 may be jointly transmitted to the UE 120 (e.g., using the same time-frequency resources). For example, the first data communication 605 and the second data communication 610 may be transmitted using a non-coherent joint transmission (NCJT) operation 615 or a coherent joint transmission (CJT) operation 620.

The NCJT operation 615 may also be referred to as a spatial division multiplexing (SDM) based operation. “NCJT” or “non-coherent joint transmission” may refer to a scenario where data from different TRPs is precoded separately for the different TRPs. In some examples, NCJT operations may be associated with an open-loop precoding technique. In some examples, an NCJT operation 615 may be performed when phase synchronization across the multiple TRPs (e.g., TRP A and TRP B) cannot be achieved (e.g., when the TRPs are driven by different clocks and/or when antenna ports of the TRPs are not quasi co-located, among other examples). For example, data intended for the UE 120 may be precoded separately on different TRPs. As shown in FIG. 6, the TRP A may be associated with N₁ antenna ports and the TRP B may be associated with N₂ antenna ports. In some examples, N₁ may be equal to N₂.

As described above, an NCJT may be used when phase synchronization between different TRPs cannot be achieved or is not readily achievable. For NCJTs, separate precoder designs need to be used at different TRPs or at different groups of TRPs. In other words, without phase synchronization, a precoder has to be configured individually within each TRP (e.g., a single TRP or a virtual TRP including a group of TRPs for which phase synchronization can be achieved), meaning that each TRP operates individually with regard to precoder design. For example, as shown in FIG. 6, the TRP A may be associated with a single layer (e.g., a single spatial layer) and the N₁ antenna ports. The TRP B may be associated with two layers (e.g., two spatial layers) and the N₂ antenna ports. This may result in 3 layers and N₁+N₂ antenna ports.

For example, the precoder for TRP A may be associated with (N₁×RI^{TRP}), where RI^{TRP} is the rank indicator for the TRP A (e.g., indicating a quantity of layers associated with the TRP A). For example, assuming N₁ has a value of four and RI^{TRP} has a value of 1 for TRP A, the precoder design (e.g., V_{A}) for the TRP A may be associated with a 4×1 matrix. The precoder for TRP B may be associated with (N₂×RI^{TRP}), where RI^{TRP} is the rank indicator for the TRP B (e.g., indicating a quantity of layers associated with the TRP B). For example, assuming N₁ has a value of four and RI^{TRP} has a value of 2 for TRP B, the precoder design (e.g., V_{B}) for the TRP A may be associated with a 4×2 matrix. For example, precoding for the NCJT may be represented as

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] ,$$

where V_{A} is the precoder for TRP A, V_{B} is the precoder for TRP B, X_{A} is the data to be transmitted by TRP A (e.g., for the first data communication 605, being associated with a 1×1 matrix), and X_{B} is the data to be transmitted by the TRP B (e.g., for the second data communication 610, being associated with a 2×1 matrix).

“CJT” or “coherent joint transmission” may refer to a scenario where data from different TRPs is jointly precoded. In some examples, CJT operations may be associated with a closed-loop precoding technique. In some examples, a CJT operation 620 may be performed when phase synchronization across the multiple TRPs (e.g., TRP A and TRP B) can be achieved. For example, a coherent joint transmission may be achieved when phase synchronization across a group of TRPs is possible (e.g., when the TRPs are driven by a same clock, and/or when antenna ports, associated with the group of TRPs, are quasi co-located, among other examples), thereby allowing a joint precoder design to be used by the group of TRPs (e.g., by TRP A and TRP B). In such cases, the group of TRPs may be considered as a single (e.g., virtual) TRP within which a coherent precoder is configured. Therefore, CJT may be beamforming for which the antennas taking part in the beamforming are not co-located but correspond to different TRPs. In some cases, a CJT may also be referred to as a joint transmission or a co-phased transmission. In some examples, zero-forcing beamforming, block-diagonal zero-forcing (BD-ZF) precoding, null steering precoding, and/or other joint precoding techniques may be used for the CJT operation 620.

For example, as shown in FIG. 6, the first data communication 605 and the second data communication 610 may be jointly transmitted as a two layer transmission (e.g., rather than the three layers used in the NCJT operation 615). For example, the precoder design may be based at least in part on a maximum RI (e.g., a highest quantity of layers between the TRP A and the TRP B). For example, the precoder design may be based at least in part on (N_{T}×RI_{MAX}), where N_{T} is the quantity of antenna ports associated with TRP A and TRP B (e.g., may be a value of N₁+N₂) and RI_{MAX} is the greatest RI between RIs associated with the TRP A and the TRP B (e.g., two in this example). Therefore, the precoder design (e.g., V_{A}) for the TRP A may be associated with a 4×2 matrix and the precoder design (e.g., V_{B}) for the TRP B may be associated with the same 4×2 matrix. For example, as shown in FIG. 6, zero padding may be used for the precoder design (e.g., V_{A}) for the TRP A because TRP A is associated with a single layer. For example, precoding for the NCJT may be represented as

$$[ \begin{matrix}{V}_{A} \\ {V}_{B}\end{matrix} ] [ X ] = [ \begin{matrix}{V}_{A} X \\ {V}_{B} X\end{matrix} ] ,$$

where V_{A} is the precoder for TRP A, V_{B} is the precoder for TRP B, and X is the data to be jointly transmitted. In this example, the data X may be associated with a 2×1 matrix (e.g., based on the RI_{MAX} being 2).

As indicated above, FIG. 6 is provided as an example. Other examples may differ from what is described with respect to FIG. 6.

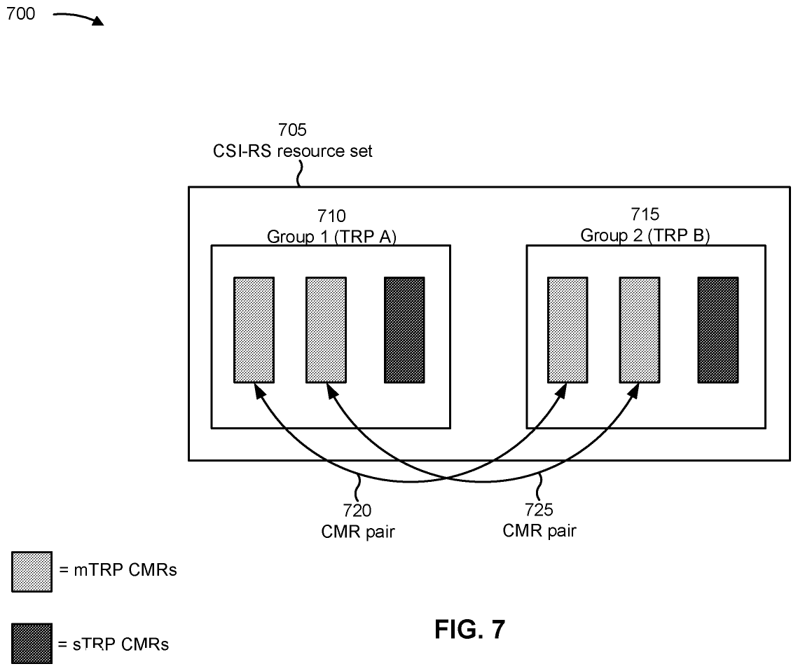

FIG. 7 is a diagram illustrating an example 700 of a CSI hypothesis configuration for non-coherent joint transmission for multi-TRP communication, in accordance with the present disclosure. As used herein “CSI hypothesis” may refer to a configuration of measurement resources (e.g., channel measurement resources (CMRs) and/or interference measurement resources (IMRs) that are expected to provide insight into channel conditions for a given channel (e.g., when measured by a UE 120). For example, the UE 120 may measure the CMR(s) and/or IMR(s) associated with a CSI hypothesis to perform channel estimations for a given channel. CMRs and/or IMRs may be CSI-RS resources and/or other reference signal resources.

For example, both single TRP (sTRP) CSI hypotheses and multi-TRP (mTRP) CSI hypotheses may be configured for a UE 120. The sTRP CSI hypotheses and the mTRP CSI hypotheses may be applicable to a single panel codebook, such as a type-/single-panel codebook (e.g., as defined, or otherwise fixed, by a wireless communication standard, such as the 3GPP). In other words, the UE 120 may be configured to perform NCJT CSI estimations using the configured CSI hypotheses.

For example, a UE 120 may be configured with a CSI-RS resource set 705. The CSI-RS resource set 705 may be associated with a first group 710 and a second group 715. The first group 710 and/or the second group 715 may be referred to as CMR groups. As shown in FIG. 7, each group may be associated with a respective TRP. For example, the first group 710 may be associated with the TRP A and the second group 715 may be associated with the TRP B. In other words, the first group 710 may include CMRs associated with the TRP A and the second group 715 may include CMRs associated with the TRP B.

In some examples, one or more pairs of CMRs may be configured for mTRP hypotheses. For example, N CMR pairs may be configured. In some cases, N may be less than or equal to two (for example, where the quantity of TRPs is limited to, or fixed at, two). A CMR pair may include a first CMR from the first group 710 and a second CMR from the second group 715. In the example shown in FIG. 7, N is two. For example, a first CMR pair 720 may include a first CMR from the first group 710 and a first CMR from the second group 715. A second CMR pair 725 may include a second CMR from the first group 710 and a second CMR from the second group 715. A CMR pair may be configured as part of an mTRP CSI hypothesis (e.g., the UE 120 may measure each CMR to obtain channel information associated with each of the multiple TRPs).

Additionally, as shown in FIG. 7, the groups may include one or more CMRs associated with sTRP CSI estimations. For example, an sTRP CMR may be a single CMR that is associated with a given TRP (e.g., for channel estimations that are only associated with that given TRP). For example, M sTRP hypotheses for the two TRPs (TRP A and TRP B) may be configured (e.g., M may or may not include the N mTRP CMRs). For example, the first group 710 may include M₁ STRP CMRs and the second group 715 may include M₂ STRP CMRs.

In addition to one or more CMRs, a CSI hypothesis may be associated with one or more IMRs (e.g., that are associated with measuring interference associated with a channel). In some cases, one (e.g., a single) IMR may be configured for each CSI hypothesis. For example, N+M IMRs may be configured for the CSI-RS resource set 705.

The UE 120 may measure the measurement resources associated with a CSI hypothesis. The UE 120 may transmit, to one or more TRPs or to a network entity associated with the TRPs, a CSI report indicating information associated with the measurements. For example, for mTRP CSI hypotheses, the UE 120 may report two PMIs, two RIs, and one CQI associated with a given mTRP CSI hypothesis. In some aspects, the UE 120 may transmit an indication of a CRI associated with one or more of the configured CSI hypotheses. For example, the UE 120 may report a best mTRP CSI hypothesis (e.g., an mTRP CSI hypothesis associated with the best measurement value(s)) and Y best sTRP CSI hypotheses by indicating CRIs associated with the respective CSI hypotheses. A value of Y may be RRC configured for the UE 120. For example, Y may be configured to have a value of 0, 1, 2, or another value. When Y is associated with a value of 2, the first and second reported sTRP hypotheses may be from the first group 710 and the second group 715, respectively. In other words, the UE 120 may report a best sTRP CSI hypothesis from the first group 710 and a best sTRP CSI hypothesis from the second group 715. For example, when Y=0, the UE 120 may report one CRI with log₂ N bits. When Y=1, the UE 120 may report two CRIs with a first CRI having log₂ N bits and a second CRI having log₂ (M₁+M₂) bits. When Y=2, the UE 120 may report three CRIs with a first CRI having log₂ N bits, a second CRI having log₂ (M₁) bits, and a third CRI having log₂ (M₂) bits.

In some other aspects, the UE 120 may report a best CSI hypothesis (e.g., by reporting an associated CRI) from all of the configured CSI hypotheses (e.g., including the mTRP hypotheses and sTRP hypotheses). For example, the UE 120 may report a single CRI having log₂ (N+M₁+M₂) bits.

As described elsewhere herein, some wireless network deployments may include more than two TRPs that communicate with a given UE. For example, to enable TRPs and/or UEs to communicate via a greater quantity of ports (e.g., antenna ports), additional TRPs may be needed. For example, a single TRP or panel with the large quantity of ports (e.g., 32 ports) may result in an antenna array size that is not practical for real-world deployment. Therefore, the large quantity of ports may be distributed among multiple TRPs (e.g., three TRPs, four TRPs, or more TRPs).

Additionally, as described above, in some wireless network deployments, CJT may be used among multiple TRPs for improved network resource utilization. However, there are currently no defined mechanisms or operations for a UE to report detailed channel knowledge for multiple TRPs associated with CJT. Additionally, deployments with more than two TRPs present additional complexities for CSI reporting and acquisition because there are increased quantities of possible channels to be measured and/or reported for (e.g., there are more possible combinations, such as a four-TRP channel, and/or a three-TRP channel, among other examples). Additionally, there are currently no defined mechanisms or operations for a UE to report CSI for CJT associated with a type-II codebook (e.g., only CSI reporting associated with Type-I codebooks, associated with a single beam, single antenna, or single transmission configuration indicator (TCI) state) is currently defined). Type-II codebooks may be associated with multiple beams, multiple antennas, and/or multiple TCI states, introducing additional complexities for defining CSI reporting and acquisition associated with the Type-II codebooks. Therefore, additional CSI hypotheses configuration mechanisms and/or CSI reporting mechanisms for CJT mTRP operations need to be defined.

Some techniques and apparatuses described herein enable a CSI hypotheses configuration for CJT scenarios. For example, a UE 120 may receive configuration information indicating a set of CSI hypotheses associated with CJT CSI estimations. The UE 120 may transmit a CSI report indicating one or more CRIs associated with one or more CSI hypotheses of the set of CSI hypotheses. In some aspects, each CRI of the one or more CRIs is associated with a respective CSI hypothesis from the one or more CSI hypotheses. In some aspects, the set of CSI hypotheses may be configured on a CSI-RS resource level within a CSI-RS resource set. In some other aspects, the set of CSI hypotheses may be configured on a port group level within a single CSI-RS resource. For example, within a CSI-RS resource set, CSI hypotheses with different combinations of TRPs can be configured for a UE to report Type-II CJT CSI (e.g., CSI estimation information associated with CJT and a Type-II codebook).

As a result, the UE 120 may be enabled to identify CMRs and/or IMRs to be measured for various combinations of TRPs. This may enable the UE 120 to measure CSI associated with various CJT channels from multiple TRPs. Moreover, the UE 120 may be enabled to report one or more CRIs, each associated with one of the CSI hypotheses. This may enable the network (e.g., a network entity) to identify a best combination of TRPs to serve the UE 120 for CJT scenarios. As a result, the network entity may be enabled to make improved determinations as to various transmission parameters (e.g., transmission power, rank, quantity of layers, among other examples) for mTRP CJT communications associated with the UE 120. This may improve a performance of the mTRP CJT communications and improve network resource utilization (e.g., by enabling multiple TRPs to effectively communicate with the UE 120 using mTRP CJT communications).

As indicated above, FIG. 7 is provided as an example. Other examples may differ from what is described with respect to FIG. 7.

FIG. 8 is a diagram of an example 800 associated with a CSI hypotheses configuration for CJT scenarios, in accordance with the present disclosure. As shown in FIG. 8, a network entity (e.g., the network entity 110) may communicate with a UE (e.g., UE 120). In some aspects, the network entity 110 and the UE 120 may be part of a wireless network (e.g., the wireless network 100). The UE 120 and the network entity 110 may have established a wireless connection prior to operations shown in FIG. 8. The network entity 110 and the UE 120 may communicate via multiple TRPs (e.g., a TRP A, a TRP B, a TRP C, and/or a TRP D, among other examples). For example, the multiple TRPs may be associated with the network entity 110. Alternatively, a first one or more of the TRPs may be associated with the network entity 110 and a second one or more of the TRPs may be associated with another network entity. For example, the network entity 110 may be a DU and the TRPs may be RUs. As another example, the network entity 110 may be a CU and the TRPs may be DUs or RUs. As another example, the TRPs may be antenna panels or antenna arrays for the network entity 110 that are distributed in the wireless network 100. Although examples are described herein associated with CSI-RS resources being configured as CMRs and/or IMRs for the UE 120, other reference signals may be configured as CMRs and/or IMRs for the UE 120 in a similar manner as described herein (e.g., the CSI-RS resource set(s) or CSI-RS resources may be resource sets or resource for other reference signals).

As shown by reference number 805, the network entity 110 may transmit configuration information intended for the UE 120 (e.g., to the UE 120, to another network entity, or to a TRP). The UE 120 may receive the configuration information (e.g., from the network entity 110, from another network entity, or from a TRP). In some aspects, the UE 120 may receive the configuration information via one or more of RRC signaling, one or more MAC control elements (MAC-CEs), and/or DCI, among other examples. In some aspects, the configuration information may include an indication of one or more configuration parameters (e.g., stored by the UE 120 and/or previously indicated by the network entity 110 or other network device) for selection by the UE 120, and/or explicit configuration information for the UE 120 to use to configure itself, among other examples.

In some aspects, the configuration information may indicate that the UE 120 is to perform CJT CSI estimation associated with mTRP operations. In some aspects, the configuration information may indicate a set of CSI hypotheses associated with CJT CSI estimations. For example, a CSI hypothesis, from the set of CSI hypotheses, may include a configuration of one or more CMRs, and/or one or more IMRs associated with the one or more CMRs. For example, the configuration information may indicate CSI hypotheses (e.g., CMR and/or IMR configurations) for mTRP CJT CSI estimations. In some aspects, the configuration information may be associated with a CSI-RS resource set configuration. For example, the CSI hypotheses may be indicated or configured via a CSI-RS resource set configuration. In some aspects, the CSI-RS resource set may only be associated with CJT CSI estimations. In some other aspects, the CSI-RS resource set may only be associated with both CJT CSI estimations and NCJT CSI estimations.

In some aspects, the CSI-RS resource set configuration includes configurations for a set of CSI-RS resources. The set of CSI hypotheses may be associated with different CSI-RS resources from the set of CSI-RS resources. For example, one or more CSI-RS resources may be configured as one or more CMRs for a CSI hypothesis. In other words, CMRs for the set of CSI hypotheses may be configured on a CSI-RS resource basis (e.g., a first CMR may be defined as a first CSI-RS resource and a second CMR may be defined as a second CSI-RS resource).

In some aspects, the CSI-RS resource set may be associated with one or more CMR groups associated with respective TRPs that are associated with the network entity 110. For example, a single CMR group may be associated with a single TRP. For example, assuming four TRPs (e.g., TRP A, TRP B, TRP C, and TRP D), the CSI-RS resource set may be associated with four CMR groups. For example, a first CMR group may include CMRs associated with the TRP A, a second CMR group may include CMRs associated with the TRP B, a third CMR group may include CMRs associated with the TRP C, and a fourth CMR group may include CMRs associated with the TRP D. Each CMR group may include one or more CSI-RS resources (e.g., that are included in the CSI-RS resource set) that are configured as an mTRP CMR or an sTRP CMR associated with a given TRP. In such examples, a CSI hypothesis, from the set of CSI hypotheses, may include a configuration of a CMR from each CMR group of the one or more CMR groups and a configuration of an IMR associated with the CSI hypothesis. In other words, a CJT CSI hypothesis may include a CMR from the first CMR group, a CMR from the second CMR group, a CMR from the third CMR group, a CMR from the fourth CMR group, and so on.

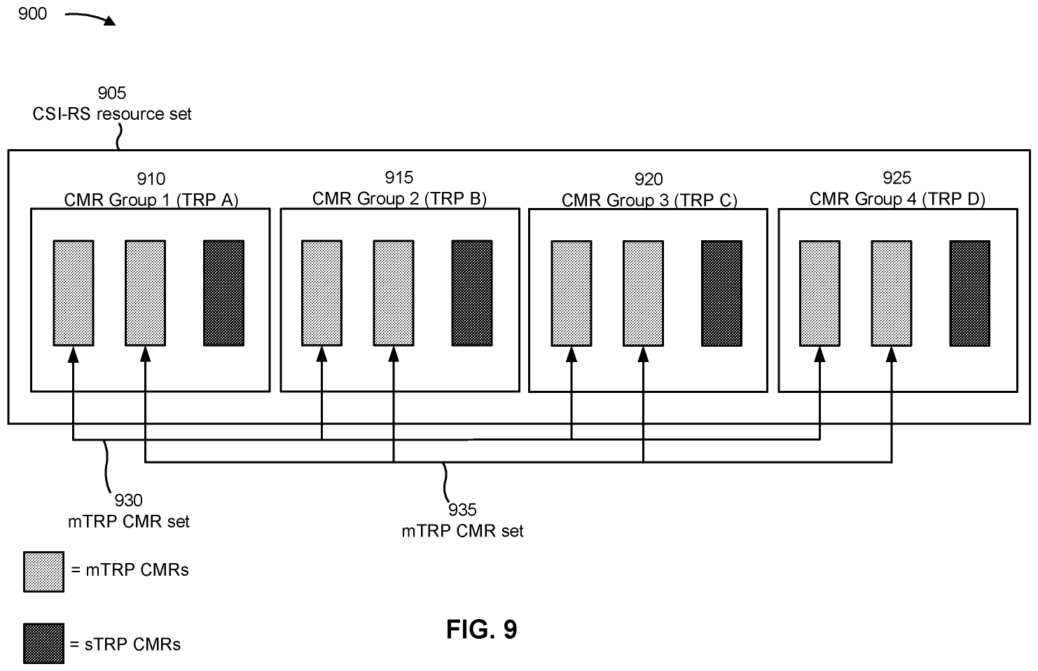

In such examples, each CMR group of the one or more CMR groups includes a first quantity (e.g., N) of CMRs that are associated with multi-TRP CSI estimations. In other words, each CMR group may include the same quantity of multi-TRP CMRs (e.g., one, two, or another quantity). Additionally, each CMR group of the one or more CMR groups includes the first quantity or a second quantity of CMRs that are associated with single TRP CSI estimations. In some aspects, the CMR groups may include the same quantity of sTRP CMRs or different quantities of sTRP CMRs. For example, each CMR group may include M sTRP CMRs. Alternatively, the first CMR group may include M₁ STRP CMRs, the second CMR group may include M₂ STRP CMRs, the third CMR group may include M₃ STRP CMRs, and the fourth CMR group may include M₄ sTRP CMRs. Therefore, the configuration information may indicate N+M₁+M₂+M₃+M₄ CSI hypotheses. Additionally, the configuration information may indicate N+M₁+M₂+M₃+M₄ IMR configurations. In other words, each combination of CMRs or each sTRP CMR may be associated with an IMR (e.g., to configure the CSI hypothesis). An example of the CMR group, CSI-RS resource based CJT CSI hypotheses configuration is depicted in FIG. 9.

As another example of a CSI-RS resource based CJT CSI hypotheses configuration, the CSI-RS resource set may be associated with a set of CMRs (e.g., CSI-RS resources) associated with respective TRPs that are associated with the network entity 110. In other words, rather than a CMR group being associated with respective TRPs (e.g., as described above), the set of CMRs (e.g., CSI-RS resources) may be associated with respective TRPs. For example, a single CMR, from the set of CMRs, may be associated with a single TRP. Assuming four TRPs (e.g., TRP A, TRP B, TRP C, and TRP D), the CSI-RS resource set may be associated with four CMRs. For example, a first CMR may be associated with the TRP A, a second CMR may be associated with the TRP B, a third CMR group may be associated with the TRP C, and a fourth CMR may be associated with the TRP D. For example, within a CMR set (e.g., a CSI-RS resource set), one CMR may correspond to one TRP.

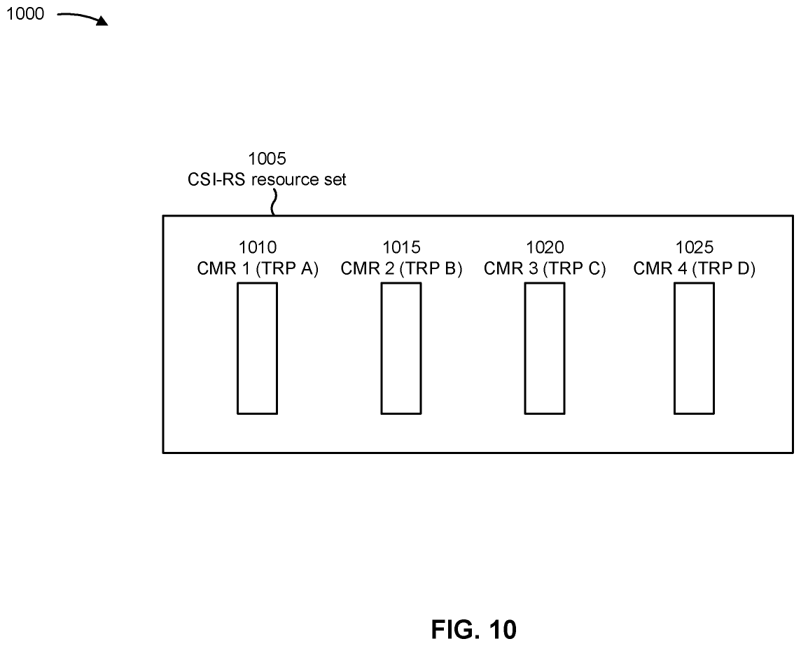

In such examples, the configuration information includes an indication of one or more CMRs, from the set of CMRs, that are included in respective CSI hypotheses from the set of CSI hypotheses. For example, combinations of the CMRs are configured (e.g., by bitmaps) for mTRP CSI hypotheses or sTRP CSI hypotheses. For example, the indication of the one or more CMRs may include a bitmap. For example, a bit in the bitmap may be mapped to, or associated with, a given CMR included in the CSI-RS resource set. The configuration information may indicate one or more bitmaps to configure one or more CJT CSI hypotheses (e.g., one bitmap may configure one CSI hypothesis). For example, the configuration information may indicate the bitmaps {1111}, {1111}, {1011}, {1010}, {1000}, {0100}, {0010}, and {0001} to configure eight CSI hypotheses. For example, assuming a CSI-RS resource set of {CMR 1 (TRP A), CMR 2 (TRP B), CMR 3 (TRP C), CMR 4 (TRP D)}, the bitmaps may configure combinations of {A,B,C,D} (e.g., an mTRP CSI hypothesis associated with TRP A, TRP B, TRP C, and TRP D), {A,B,C,D} (e.g., an mTRP CSI hypothesis associated with TRP A, TRP B, TRP C, and TRP D), {A,C,D} (e.g., an mTRP CSI hypothesis associated with TRP A, TRP C, and TRP D), {A,C} (e.g., an mTRP CSI hypothesis associated with TRP A and TRP C), {A} (e.g., an sTRP CSI hypothesis associated with TRP A) {B}, (e.g., an sTRP CSI hypothesis associated with TRP B), {C} (e.g., an sTRP CSI hypothesis associated with TRP C), and {D} (e.g., an sTRP CSI hypothesis associated with TRP D). As described above, the configuration information may indicate the same bitmap (e.g., {1111}) for two or more CSI hypotheses). In such examples, the two or more CSI hypotheses may be differentiated by being associated with different IMRs. For example, a first CSI hypothesis associated with the set of CMRs may be associated with a first IMR and a second CSI hypothesis associated with the set of CMRs may be associated with a second IMR. For example, for the eight bitmaps described above, eight IMRs may be configured by the network entity 110. An example of the CMR, CSI-RS resource based CJT CSI hypothesis configuration is depicted in FIG. 10.

As another example, the set of CSI hypotheses may be associated with different antenna port groups. For example, the CSI hypotheses may be configured on a port group (e.g., an antenna port group or a CSI-RS port group) basis. A port group may include one or more ports. For example, the CSI-RS resource set may be associated with a set of CMRs associated with different quantities of antenna ports. For example, the CSI-RS resource set may include a first one or more CMRs (e.g., a first one or more CSI-RS resources) associated with a first quantity of ports (e.g., 32 ports), a second one or more CMRs (e.g., a second one or more CSI-RS resources) associated with a second quantity of ports (e.g., 24 ports), a third one or more CMRs (e.g., a third one or more CSI-RS resources) associated with a third quantity of ports (e.g., 16 ports), and/or a fourth one or more CMRs (e.g., a fourth one or more CSI-RS resources) associated with a fourth quantity of ports (e.g., 8 ports), among other examples. In some examples, the quantity of ports associated with a given CMR may correspond with a quantity of TRPs that are associated with the given CMR. For example, a port group may include 8 ports. Therefore, a CMR that is associated with 32 ports may be associated with four port groups and four TRPs. A CMR that is associated with 24 ports may be associated with three port groups and three TRPs. A CMR that is associated with 16 ports may be associated with two port groups and two TRPs. A CMR that is associated with 8 ports may be associated with one port group and one TRP (e.g., a single TRP).

For example, the CSI-RS resource set may include one or more CMRs having a quantity of ports corresponding to a single port group (or a single TRP) for each TRP associated with the UE 120. The CSI-RS resource set may include one or more CMRs having a quantity of ports corresponding to a four port groups (e.g., four TRPs). As another example, the CSI-RS resource set may include one or more CMRs having a quantity of ports corresponding to a three port groups (e.g., three TRPs), with each CMR being associated with a different combination of three TRPs from four or more TRPs that are associated with the UE 120. In some aspects, different CMRs with a same quantity of ports may be configured for different CSI hypotheses (e.g., with different CMRs being associated with different IMRs). For example, a first CSI hypothesis, from the set of CSI hypotheses, may include a first CMR, from the set of CMRs, associated with a first quantity of antenna ports and a first IMR. A second CSI hypothesis, from the set of CSI hypotheses, may include a second CMR, from the set of CMRs, associated with a second quantity of antenna ports and a second IMR. As another example, a third CSI hypothesis, from the set of CSI hypotheses, may include a first CMR, from the set of CMRs, associated with a first quantity of antenna ports and a first IMR. A fourth CSI hypothesis, from the set of CSI hypotheses, may include the first CMR and a second IMR.

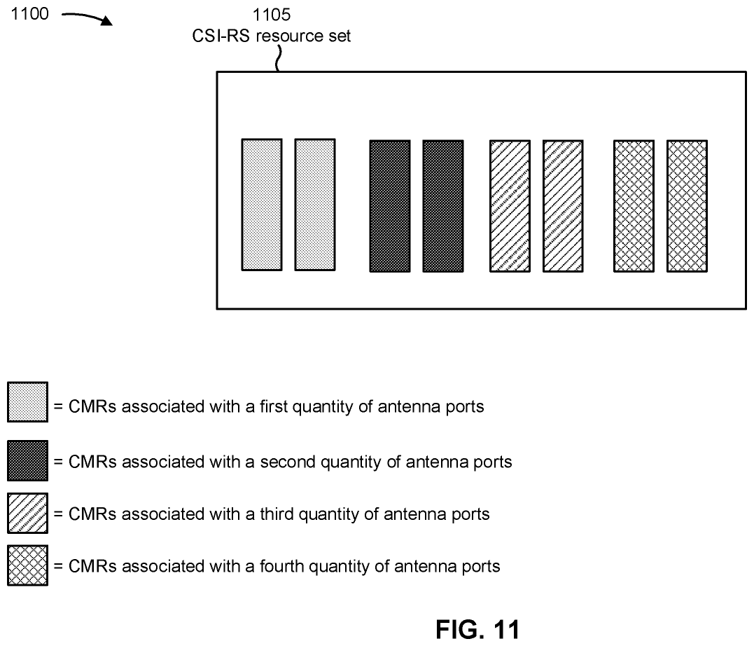

In such examples, the UE 120 may not be aware of (e.g., may not receive an indication of) which CMR is associated with which TRPs. In other words, which TRPs are associated with which CMRs and/or port groups may be transparent to the UE 120. Rather, the UE 120 may measure the CMRs and report one or more CRIs to the network entity 110 (e.g., associated with a best one or more measurements from the set of CSI hypotheses). The network entity 110 may identify a TRP combination for CJT for the UE 120 based at least in part on the reported one or more CRIs. An example of the CMR, port group based CJT CSI hypothesis configuration is depicted in FIG. 11.

As another example of a port group based CJT CSI hypothesis configuration, the configuration information may include a configuration for a CSI-RS resource as a CMR for CJT. In other words, a single CMR (e.g., a single CSI-RS resource) may be configured for the UE 120 to perform CJT CSI estimation. The CSI-RS resource may be associated with a set of port groups (e.g., a set of antenna port groups and/or a set of CSI-RS port groups). An antenna port group, from the set of antenna port groups, may be associated with a TRP from multiple TRPs associated with the network entity 110 and/or the UE 120. For example, a single antenna port group may be associated with a single TRP. In such examples, a CSI hypothesis, from the set of CSI hypotheses, includes one or more antenna port groups, from the set of antenna port groups, and a configuration of an IMR associated with the CSI hypothesis.

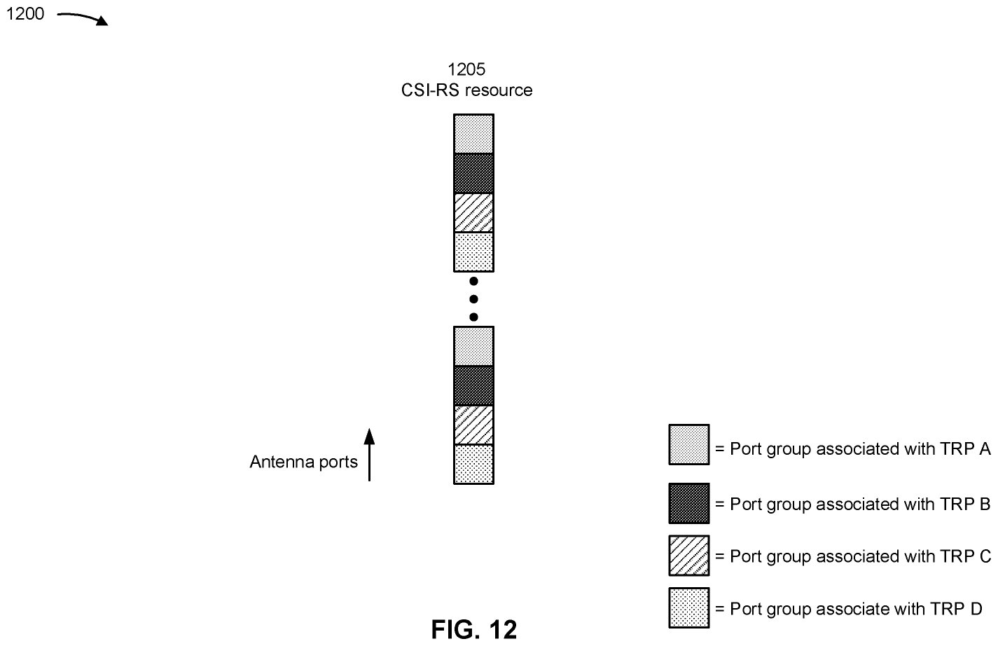

For example, the configuration information may include an indication of the one or more antenna port groups, from the set of antenna port groups, that are associated with the CSI hypothesis. In some aspects, the indication of the one or more antenna port groups may include a bitmap. For example, in a similar manner as described above, the configuration information may indicate a bitmap for each CSI hypothesis, where a bitmap associated a given CSI hypothesis indicates the antenna port groups (e.g., of the CMR) that are associated with the given CSI hypothesis. For example, within a CMR, one port group corresponds to one TRP. Combinations of the port groups may be configured (e.g., by bitmaps) for mTRP or sTRP CSI hypotheses. Additionally, the configuration information may indicate that one CMR is mapped to one IMR or multiple IMRs (e.g., to enable different CSI hypotheses to be configured for the same antenna port groups). An example of this CMR, port group based CJT CSI hypothesis configuration is depicted in FIG. 12.

In some aspects, the configuration information may indicate that a CSI-RS resource set is associated with both CJT CSI estimations and NCJT CSI estimations. For example, a CSI-RS resource set may be associated with 2 levels of CSI estimations. For a first level associated with CJT CSI estimations, the CSI-RS resource set may include a set of CMR groups, each CMR group from the set of CMR groups being associated with respective TRPs that are associated with the network entity 110 and/or the UE 120. Each CMR group may include one or more CMRs associated with mTRP CSI estimations and one or more CMRs associated sTRP CSI estimations. The configuration information may indicate that the CSI-RS resource set is associated with one or more CJT groups, each CJT group from the one or more CJT groups including one or more CMR groups from the set of CMR groups. For example, a first one or more CMR groups may be included in a first CJT group and a second one or more CMR groups may be associated with a second CJT group. A first CSI hypothesis, from the set of CSI hypotheses associated with CJT CSI estimations, may include one or more CMRs from different CMR groups included in a same CJT group. In other words, mTRP CJT CSI hypotheses may be configured as including CMRs from different CMR groups that are included in the same CJT group.

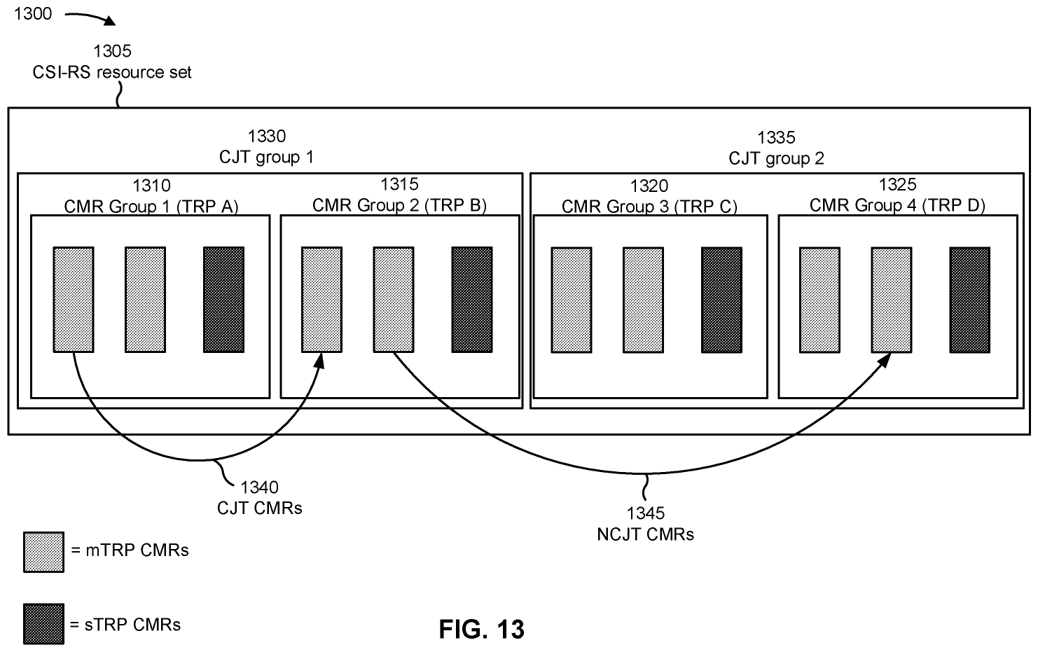

A CJT group may be defined as a combination of CMR groups. For example, the network entity 110 may determine a CJT group based at least in part on which TRPs can achieve phase coherence together. For example, the network entity 110 may group CMR groups corresponding to TRPs that can achieve phase coherence together in the same CJT group. A second CSI hypothesis, that is associated with non-CJT CSI estimations, may include one or more CMRs from different CJT groups. For example, an NCJT CSI hypothesis may include a first CMR from a first CMR group and a second CMR from a second CMR group, wherein the first CMR group and the second CMR group are included in different CJT groups. For example, TRPs associated with CMR groups in different CJT groups may not be capable of achieving phase coherence (e.g., and are therefore associated with NCJT). An example of this CJT and NCJT CSI hypotheses configuration is depicted in FIG. 13.

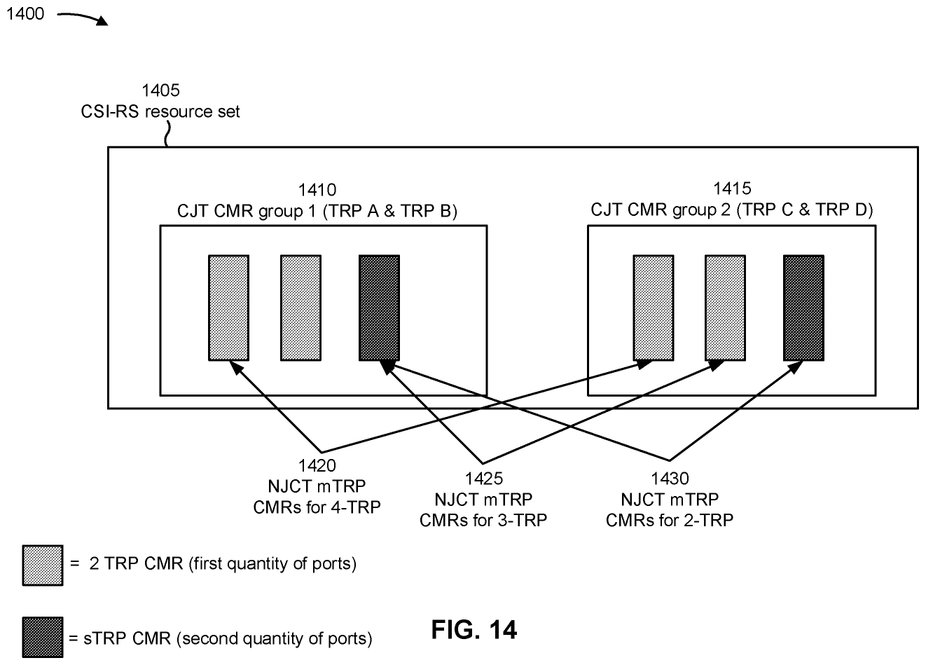

As another example of a CJT and NCJT CSI hypotheses configuration for the same CSI-RS resource set, the CSI-RS resource set may be associated with a set of CJT CMR groups. In some aspects, each CJT CMR group from the set of CJT CMR groups may be associated with one or more TRPs that are associated with the network entity 110 and/or the UE 120. Each CJT CMR group may be associated with a set of CMRs associated with different quantities of ports (e.g., antenna ports or CSI-RS ports). A first CSI hypothesis, from the set of CSI hypotheses associated with CJT CSI estimations, may include a CMR from a CJT CMR group from the set of CJT CMR groups. For example, a CMR may be associated with multiple port groups, where each port group is associated with a different TRP (e.g., in a similar manner as described elsewhere herein). Therefore, for CJT CSI estimation, a CSI hypothesis may include a given CMR and an IMR. A second CSI hypothesis, that is associated with NCJT CSI estimations, may include a first CMR from a first CJT CMR group and a second CMR from a second CJT CMR group. In other words, NCJT CSI hypotheses may be configured using CMRs included in different CJT CMR groups. An example of a CJT CMR group based CSI hypotheses configuration is depicted in FIG. 14.

As shown by reference number 810, the UE 120 may configure itself based at least in part on the configuration information. In some aspects, the UE 120 may be configured to perform one or more operations described herein based at least in part on the configuration information. For example, the UE 120 may be configured to measure CMRs and/or IMRs as indicated by the configuration information.

As shown by reference number 815, the UE 120 may perform one or more measurements in accordance with the set of CSI hypotheses. For example, the UE 120 may perform one or more measurements, associated with a given CSI hypothesis using one or more CMRs and/or an IMR that are configured for the given CSI hypothesis (e.g., configured by the configuration information). In some aspects, the UE 120 may select one or more CSI hypotheses from the set of configured CSI hypotheses to be associated with the measurements. For example, in some cases, the UE 120 may perform measurements associated with less than all of the configured CSI hypotheses. The UE 120 may obtain measurement values based at least in part on performing the measurements. The UE 120 may compare the measurement values to identify one or more CSI hypotheses that are associated with best or highest measurement values.

As shown by reference number 820, the UE 120 may transmit a CSI report intended for the network entity 110. The UE 120 may transmit the CSI report to the network entity 110 or to another network entity or TRP (e.g., to be forwarded to the network entity 110). The network entity 110 may receive the CSI report associated with the UE 120 (e.g., from the UE 120 or from another network entity or TRP). The CSI report may indicate one or more CRIs associated with one or more CSI hypotheses of the set of CSI hypotheses. In some aspects, each CRI of the one or more CRIs is associated with a respective CSI hypothesis from the one or more CSI hypotheses. In other words, a single CRI may be associated with a single CSI hypothesis (e.g., as indicated by the configuration information). For example, the UE 120 may report one or more CRIs associated with mTRP CJT CSI estimations. Additionally, or alternatively, the UE 120 may report one or more CRIs associated with mTRP NCJT CSI estimations. Additionally, or alternatively, the UE 120 may report one or more CRIs associated with sTRP CSI estimations.

The network entity 110 may determine a TRP configuration for the UE 120 based at least in part on the CSI report. For example, the network entity 110 may determine a combination of TRPs to be associated with the UE 120 (e.g., based at least in part on the TRPs associated with a CRI reported by the UE 120). Additionally, the network entity 110 may determine whether CJT may be used for the UE 120 (e.g., based at least in part whether a CRI reported by the UE 120 is associated with mTRP CJT). As another example, the network entity 110 may determine one or more transmission parameters to be associated with mTRP or sTRP operations that are associated with the UE 120, such as a transmission power, a rank, a quantity of layers, an MCS, and/or other transmission parameters. The network entity 110 may transmit the TRP configuration intended for the UE 120 (e.g., to the UE 120 or to another network entity or TRP to be forwarded to the UE 120). The UE 120 may receive the TRP configuration (e.g., from the network entity 110 or from another network entity or TRP).

As a result, the UE 120 may be enabled to identify CMRs and/or IMRs to be measured for various combinations of TRPs. This may enable the UE 120 to measure CSI associated with various CJT channels from multiple TRPs. Moreover, the UE 120 may be enabled to report one or more CRIs, each associated with one of the CSI hypotheses. This may enable the network (e.g., a network entity) to identify a best combination of TRPs to serve the UE 120 for CJT scenarios. As a result, the network entity may be enabled to make improved determinations as to various transmission parameters (e.g., transmission power, rank, quantity of layers, among other examples) for mTRP CJT communications associated with the UE 120. This may improve a performance of the mTRP CJT communications and improve network resource utilization (e.g., by enabling multiple TRPs to effectively communicate with the UE 120 using mTRP CJT communications).

As indicated above, FIG. 8 is provided as an example. Other examples may differ from what is described with respect to FIG. 8.

FIG. 9 is a diagram of an example 900 associated with a CSI-RS resource based CSI hypotheses configuration for CJT scenarios, in accordance with the present disclosure. As shown in FIG. 9, a network entity 110 may configure a CSI-RS resource set 905 for a UE 120. The CSI-RS resource set 905 may include a set of CMR groups.

A quantity of CMR groups associated with the CSI-RS resource set 905 may be associated with, or based at least in part on, a quantity of TRPs associated with the UE 120. For example, as shown in FIG. 9, the UE 120 may be configured to communicate with four TRPs associated with the network entity 110 (e.g., TRP A, TRP B, TRP C, and TRP D). The CSI-RS resource set may be associated with a first CMR group 910 (e.g., that is associated with the TRP A), a second CMR group 915 (e.g., that is associated with the TRP B), a third CMR group 920 (e.g., that is associated with the TRP C), and a fourth CMR group 925 (e.g., that is associated with the TRP D). Each CMR group may include one or more CMRs associated with mTRP CSI estimations and one or more CMRs associated with sTRP CSI estimations. The CMRs included in a given CMR group may all be associated with the same TRP. For example, the CMRs included in the first CMR group 910 may be associated with the TRP A and the CMRs included in the third CMR group 920 may be associated with the TRP C. In some aspects, each CMR group may include the same quantity of mTRP CMRs. The CMR groups may include the same quantity of sTRP CMRs. Alternatively, the CMR groups may include different quantities of sTRP CMRs.

As shown in FIG. 9, an mTRP CMR set 930 may be configured for an mTRP CJT CSI estimation. For example, the mTRP CMR set 930 may include a CMR from each CMR group that is associated with the CSI-RS resource set 905. For example, as shown in FIG. 9, the mTRP CMR set 930 may include a first CMR from the first CMR group 910, a first CMR from the second CMR group 915, a first CMR from the third CMR group 920, and a first CMR from the fourth CMR group 925. In other words, a first CJT CSI hypothesis may be configured as the CMRs associated with a first index value from each CMR group (e.g., a first, or lowest, index value). As another example, an mTRP CMR set 935 may be configured for an mTRP CJT CSI estimation. For example, the mTRP CMR set 935 may include a CMR from each CMR group that is associated with the CSI-RS resource set 905. For example, as shown in FIG. 9, the mTRP CMR set 930 may include a second CMR from the first CMR group 910, a second CMR from the second CMR group 915, a second CMR from the third CMR group 920, and a second CMR from the fourth CMR group 925. In other words, a second CJT CSI hypothesis may be configured as the CMRs associated with a second index value from each CMR group (e.g., a second index value, a second lowest index value, or a highest index value). An sTRP CSI hypothesis may be configured using an sTRP CMR from a given CMR group. Each CSI hypothesis may be associated with a configured IMR.

As indicated above, FIG. 9 is provided as an example. Other examples may differ from what is described with respect to FIG. 9.

FIG. 10 is a diagram of an example 1000 associated with a CSI-RS resource based CSI hypotheses configuration for CJT scenarios, in accordance with the present disclosure. As shown in FIG. 10, a network entity 110 may configure a CSI-RS resource set 1005 for a UE 120. The CSI-RS resource set 1005 may include a set of CMRs.

A quantity of CMRs associated with the CSI-RS resource set 1005 may be associated with, or based at least in part on, a quantity of TRPs associated with the UE 120. For example, as shown in FIG. 10, the UE 120 may be configured to communicate with four TRPs associated with the network entity 110 (e.g., TRP A, TRP B, TRP C, and TRP D). The CSI-RS resource set may be associated with a first CMR 1010 (e.g., that is associated with the TRP A), a second CMR 1015 (e.g., that is associated with the TRP B), a third CMR 1020 (e.g., that is associated with the TRP C), and a fourth CMR 1025 (e.g., that is associated with the TRP D). The network entity 110 may configure one or more CSI hypotheses by indicating which CMRs are associated with each CSI hypothesis (e.g., via one or more bitmaps or another indication). For example, each bit in the bitmap may correspond to a CMR included in the CSI-RS resource set 1005. For a given bit, the network entity 110 may include a value of “1” in the bitmap if the CMR is associated with the CSI hypothesis and a value of “0” in the bitmap if the CMR is not associated with the CSI hypothesis.

For example, a bitmap of {1, 1, 1, 1} may indicate that the first CMR 1010, the second CMR 1015, the third CMR 1020, and the fourth CMR 1025 are configured for the CSI hypothesis associated with the bitmap. A bitmap of {1, 0, 1, 1} may indicate that the first CMR 1010, the third CMR 1020, and the fourth CMR 1025 (e.g., but not the second CMR 1015) are configured for the CSI hypothesis associated with the bitmap (e.g., for a three-TRP CJT CSI estimation). A bitmap of {1, 0, 0, 1} may indicate that the first CMR 1010 and the fourth CMR 1025 (e.g., but not the second CMR 1015 or the third CMR 1020) are configured for the CSI hypothesis associated with the bitmap (e.g., for a two-TRP CJT CSI estimation). A bitmap of {1, 0, 0, 0} may indicate that the first CMR 1010 (e.g., but not the second CMR 1015, the third CMR 1020, or the fourth CMR 1025) are configured for the CSI hypothesis associated with the bitmap (e.g., for a single TRP CSI estimation). This may provide additional flexibility for the network entity 110 to configure different CSI hypotheses while also conserving a quantity of CMRs that need to be configured for the different CSI hypotheses.

As indicated above, FIG. 10 is provided as an example. Other examples may differ from what is described with respect to FIG. 10.

FIG. 11 is a diagram of an example 1100 associated with a port group based CSI hypotheses configuration for CJT scenarios, in accordance with the present disclosure. As shown in FIG. 11, a network entity 110 may configure a CSI-RS resource set 1105 for a UE 120. The CSI-RS resource set 1105 may include a set of CMRs. As shown in FIG. 11, the set of CMRs may be associated with different quantities of ports (e.g., antenna ports or CSI-RS ports).

For example, the CSI-RS resource set 1105 may include a first one or more CMRs associated with a first quantity of ports. The CSI-RS resource set 1105 may include a second one or more CMRs associated with a second quantity of ports. The CSI-RS resource set 1105 may include a third one or more CMRs associated with a third quantity of ports. The CSI-RS resource set 1105 may include a fourth one or more CMRs associated with a fourth quantity of ports. For example, the first quantity of ports may be associated with a first quantity of TRPs (e.g., four TRPs). The second quantity of ports may be associated with a second quantity of TRPs (e.g., three TRPs). The third quantity of ports may be associated with a third quantity of TRPs (e.g., two TRPs). The fourth quantity of ports may be associated with a fourth quantity of TRPs (e.g., a single TRP). For example, each TRP may be associated with Sports. The UE 120 may be associated with P TRPs. Therefore, the first quantity may be based at least in part on S×P, the second quantity may be based at least in part on S×(P−1), the third quantity may be based at least in part on S×(P−2), and so on. For example, assuming S is eight and P is four, the first quantity of ports may be 32, the second quantity of ports may be 24, the third quantity of ports may be 16, and the fourth quantity of ports may be 8.

CMRs associated with the same quantity of ports may be associated with different combinations of TRPs. For example, a first CMR associated with the second quantity of ports may be associated with a first combination of TRPs (e.g., TRP A, TRP B, and TRP C), and a second CMR associated with the second quantity of ports may be associated with a second combination of TRPs (e.g., TRP A, TRP C, and TRP D). Therefore, a CSI hypothesis may be defined as a CMR and an IMR, where a quantity of ports associated with the CMR indicates the quantity of TRPs associated with the CSI hypothesis.

As indicated above, FIG. 11 is provided as an example. Other examples may differ from what is described with respect to FIG. 11.

FIG. 12 is a diagram of an example 1200 associated with a port group based CSI hypotheses configuration for CJT scenarios, in accordance with the present disclosure. As shown in FIG. 12, a network entity 110 may configure a CSI-RS resource 1205. The CSI-RS resource 1205 may be a CMR for CJT CSI estimations. As shown in FIG. 12, the CSI-RS resource 1205 may be associated with one or more port groups (e.g., antenna port groups or CSI-RS port groups). Each port group may correspond to a respective TRP.

For example, as shown in FIG. 12, the UE 120 may be configured to, or capable of, communicating with four TRPs associated with the network entity 110 (e.g., TRP A, TRP B, TRP C, and TRP D). The CSI-RS resource 1205 may be associated with a first port group (e.g., that is associated with the TRP A), a second port group (e.g., that is associated with the TRP B), a third port group (e.g., that is associated with the TRP C), and a fourth port group (e.g., that is associated with the TRP D). The network entity 110 may configure one or more CSI hypotheses by indicating which port groups are associated with each CSI hypothesis (e.g., via one or more bitmaps or another indication). For example, each bit in the bitmap may correspond to a port group associated with the CSI-RS resource 1205. For a given bit, the network entity 110 may include a value of “1” in the bitmap if the port group is associated with the CSI hypothesis and a value of “0” in the bitmap if the port group is not associated with the CSI hypothesis.

For example, a bitmap of {1, 1, 1, 1} may indicate that the first port group, the second port group, the third port group, and the fourth port group are configured for the CSI hypothesis associated with the bitmap. A bitmap of {1, 0, 1, 1} may indicate that the first port group, the third port group, and the fourth port group (e.g., but not the second port group) are configured for the CSI hypothesis associated with the bitmap (e.g., for a three-TRP CJT CSI estimation). A bitmap of {1, 0, 0, 1} may indicate that the first port group and the fourth port group (e.g., but not the second port group or the third port group) are configured for the CSI hypothesis associated with the bitmap (e.g., for a two-TRP CJT CSI estimation). A bitmap of {1, 0, 0, 0} may indicate that the first port group (e.g., but not the second port group, the third port group, or the fourth port group) are configured for the CSI hypothesis associated with the bitmap (e.g., for a single TRP CSI estimation). This may provide additional flexibility for the network entity 110 to configure different CSI hypotheses while also conserving a quantity of CMRs that need to be configured for the different CSI hypotheses.

As indicated above, FIG. 12 is provided as an example. Other examples may differ from what is described with respect to FIG. 12.

FIG. 13 is a diagram of an example 1300 associated with a CSI-RS resource based CSI hypotheses configuration for both CJT scenarios and NCJT scenarios, in accordance with the present disclosure. As shown in FIG. 13, a network entity 110 may configure a CSI-RS resource set 1305 for a UE 120. The CSI-RS resource set 1305 may include CMRs for CJT CSI estimations and for NCJT CSI estimations.

The CSI-RS resource set 1305 may include a set of CMR groups. A quantity of CMR groups associated with the CSI-RS resource set 1305 may be associated with, or based at least in part on, a quantity of TRPs associated with the UE 120. For example, as shown in FIG. 13, the UE 120 may be configured to, or capable of, communicating with four TRPs associated with the network entity 110 (e.g., TRP A, TRP B, TRP C, and TRP D). The CSI-RS resource set may be associated with a first CMR group 1310 (e.g., that is associated with the TRP A), a second CMR group 1315 (e.g., that is associated with the TRP B), a third CMR group 1320 (e.g., that is associated with the TRP C), and a fourth CMR group 1325 (e.g., that is associated with the TRP D). In other words, each CMR group may be associated with a different TRP. Each CMR group may include one or more CMRs associated with mTRP CSI estimations and one or more CMRs associated with sTRP CSI estimations. The CMRs included in a given CMR group may all be associated with the same TRP. For example, the CMRs included in the first CMR group 1310 may be associated with the TRP A and the CMRs included in the third CMR group 1320 may be associated with the TRP C. In some aspects, each CMR group may include the same quantity of mTRP CMRs. The CMR groups may include the same quantity of sTRP CMRs. Alternatively, the CMR groups may include different quantities of sTRP CMRs.

Additionally, the CSI-RS resource set 1305 may be associated with one or more CJT groups. A CJT group may include CMR groups associated with TRPs that are capable of performing CJTs with one another (e.g., that can achieve phase coherence). As shown in FIG. 13, the CSI-RS resource set 1305 may be associated with a first CJT group 1330. The first CJT group 1330 may include the first CMR group 1310 and the second CMR group 1315. For example, the TRP A and the TRP B may be capable of achieving phase coherence. Therefore, the TRP A and the TRP B may be used together for CJTs associated with the UE 120. The CSI-RS resource set 1305 may be associated with a second CJT group 1335. The second CJT group 1335 may include the third CMR group 1320 and the fourth CMR group 1325. For example, the TRP C and the TRP D may be capable of achieving phase coherence. Therefore, the TRP C and the TRP D may be used together for CJTs associated with the UE 120. In such example, TRPs associated with different CJT groups may not be capable of achieving phase coherence. For example, in the configuration depicted in FIG. 13, the TRP B and the TRP C may not be capable of achieving phase coherence and may not be used for CJTs associated with the UE 120.

As shown by reference number 1340, a CSI hypothesis for CJT CSI estimation may include one or more CMRs from CMR groups included in the same CJT group. For example, a CSI hypothesis for CJT CSI estimation may include a first CMR from the first CMR group 1310 and a first CMR from the second CMR group 1315. As another example, a CSI hypothesis for CJT CSI estimation may include a first CMR from the third CMR group 1320 and a first CMR from the fourth CMR group 1325. As shown by reference number 1345, a CSI hypothesis for NCJT CSI estimation may include one or more CMRs from CMR groups included in different CJT groups. For example, a CSI hypothesis for NCJT CSI estimation may include a CMR from the second CMR group 1315 and a CMR from the fourth CMR group 1325. As another example, a CSI hypothesis for NCJT CSI estimation may include a CMR from the first CMR group 1310, a CMR from the second CMR group 1315 and a CMR from the fourth CMR group 1325. As a result, the network entity 110 may be enabled to configure CSI hypotheses for CJT CSI estimation and for NCJT CSI estimations using the same CSI-RS resource set.

As indicated above, FIG. 13 is provided as an example. Other examples may differ from what is described with respect to FIG. 13.

FIG. 14 is a diagram of an example 1400 associated with a port group based CSI hypotheses configuration for both CJT scenarios and NCJT scenarios, in accordance with the present disclosure. As shown in FIG. 14, a network entity 110 may configure a CSI-RS resource set 1405 for a UE 120. The CSI-RS resource set 1405 may include CMRs for CJT CSI estimations and for NCJT CSI estimations.

The CSI-RS resource set 1405 may be associated with one or more CJT CMR groups. A CJT CMR group may be associated with one or more TRPs. For example, a CJT CMR group may be associated with multiple TRPs that are capable of achieving phase coherence for CJTs associated with the UE 120. As shown in FIG. 14, the CSI-RS resource set 1405 may be associated with a first CJT CMR group 1410 (e.g., that is associated with a TRP A and a TRP B) and a second CJT CMR group 1415 (e.g., that is associated with a TRP C and a TRP D).

Each CJT CMR group may include one or more CMRs. CMRs within a CJT CMR group may be associated with different quantities of ports (e.g., antenna ports or CSI-RS ports). In the example shown in FIG. 14, each CJT CMR group is associated with two TRPs. Therefore, the CMRs include one or more CMRs having a quantity of ports associated with two TRPs and one or more CMRs having a quantity of ports associated with a single TRP. In other examples, a CJT CMR group may be associated with more than two TRPs, such as three TRPs. In such examples, the CMRs may include one or more CMRs having a quantity of ports associated with three TRPs, one or more CMRs having a quantity of ports associated with two TRPs, and one or more CMRs having a quantity of ports associated with a single TRP. For example, a quantity of ports associated with a quantity of TRPs may be based at least in part on a port group size. For example, a port group may be associated with eight ports. Therefore, a quantity of ports associated with a single TRP may be eight (e.g., a single port group). As another example, a quantity of ports associated with two TRPs may be 16 (e.g., two port groups). Each CMR may be associated with one or more TRPs. For example, the first CJT CMR group 1410 may include a first mTRP CMR that is associated with the TRP A and the TRP B, a second mTRP CMR that is associated with the TRP A and the TRP B, a first sTRP CMR that is associated with the TRP A, and a second sTRP CMR that is associated with the TRP B.

A CSI hypothesis for CJT CSI estimations may be configured as a given CMR from a CJT CMR group and an IMR. For example, a CSI hypothesis for CJT CSI estimations associated with the TRP A and the TRP B may be associated with a CMR from the first CJT CMR group 1410 (e.g., where the TRP A is associated with a first set of ports of the CMR and the TRP B is associated with a second set of ports of the CMR). A CSI hypothesis for CJT CSI estimations associated with the TRP C and the TRP D may be associated with a CMR from the second CJT CMR group 1415 (e.g., where the TRP C is associated with a first set of ports of the CMR and the TRP D is associated with a second set of ports of the CMR).

A CSI hypothesis for NCJT CSI estimations may include one or more CMRs from different CJT CMR groups. For example, as shown by reference number 1420, a CSI hypothesis for NCJT CSI estimations associated with four TRPs may include a first mTRP CMR (e.g., a CMR including a quantity of ports that is associated with two TRPs) from the first CJT CMR group 1410 and a second mTRP CMR (e.g., a CMR including a quantity of ports that is associated with two TRPs) from the second CJT CMR group 1415. As another example, as shown by reference number 1425, a CSI hypothesis for NCJT CSI estimations associated with three TRPs may include an sTRP CMR (e.g., a CMR including a quantity of ports that is associated with a single TRP) from the first CJT CMR group 1410 and an mTRP CMR (e.g., a CMR including a quantity of ports that is associated with two TRPs) from the second CJT CMR group 1415. As another example, as shown by reference number 1430, a CSI hypothesis for NCJT CSI estimations associated with two TRPs may include a first sTRP CMR (e.g., a CMR including a quantity of ports that is associated with a single TRP) from the first CJT CMR group 1410 and a second sTRP CMR (e.g., a CMR including a quantity of ports that is associated with a single TRP) from the second CJT CMR group 1415.

As a result, the network entity 110 may be enabled to configure CSI hypotheses for CJT CSI estimation and for NCJT CSI estimations using the same CSI-RS resource set. For example, the network entity 110 may configure CSI hypotheses associated with CJT scenarios, NCJT scenarios, and different quantities of TRPs using the same CSI-RS resource set.

As indicated above, FIG. 14 is provided as an example. Other examples may differ from what is described with respect to FIG. 14.

FIG. 15 is a diagram illustrating an example process 1500 performed, for example, by a UE, in accordance with the present disclosure. Example process 1500 is an example where the UE (e.g., the UE 120) performs operations associated with CSI hypotheses configuration for CJT scenarios.

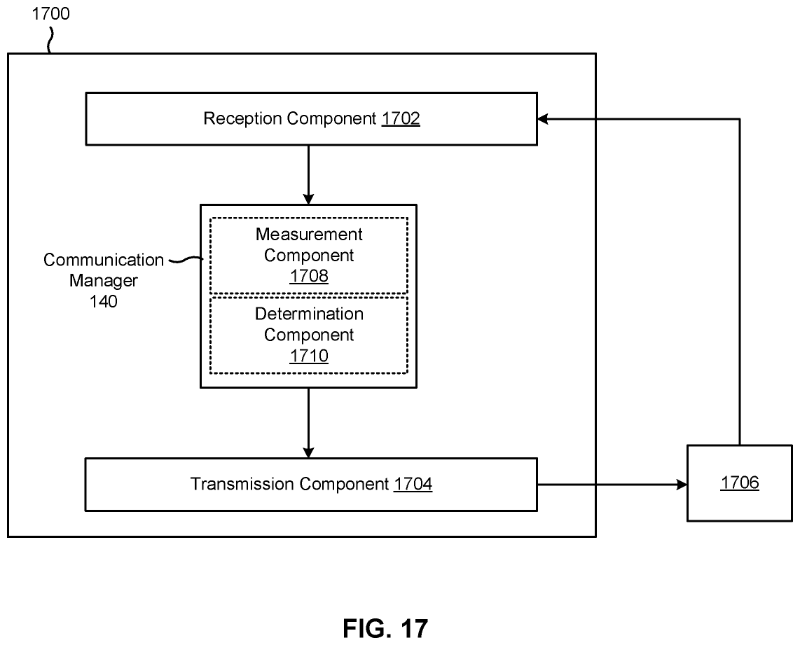

As shown in FIG. 15, in some aspects, process 1500 may include receiving, from a network entity, configuration information indicating a set of CSI hypotheses associated with CJT CSI estimations (block 1510). For example, the UE (e.g., using communication manager 140 and/or reception component 1702, depicted in FIG. 17) may receive, from a network entity, configuration information indicating a set of CSI hypotheses associated with CJT CSI estimations, as described above, for example, with reference to FIGS. 8, 9, 10, 11, 12, 13, and/or 14.

As further shown in FIG. 15, in some aspects, process 1500 may include transmitting, to the network entity, a CSI report indicating one or more CRIs associated with one or more CSI hypotheses of the set of CSI hypotheses, wherein each CRI of the one or more CRIs is associated with a respective CSI hypothesis from the one or more CSI hypotheses (block 1520). For example, the UE (e.g., using communication manager 140 and/or transmission component 1704, depicted in FIG. 17) may transmit, to the network entity, a CSI report indicating one or more CRIs associated with one or more CSI hypotheses of the set of CSI hypotheses, wherein each CRI of the one or more CRIs is associated with a respective CSI hypothesis from the one or more CSI hypotheses, as described above, for example, with reference to FIGS. 8, 9, 10, 11, 12, 13, and/or 14.

Process 1500 may include additional aspects, such as any single aspect or any combination of aspects described below and/or in connection with one or more other processes described elsewhere herein.

In a first aspect, a CSI hypothesis, from the set of CSI hypotheses, includes a configuration of at least one of one or more CMRs, or one or more IMRs associated with the one or more CMRs.

In a second aspect, alone or in combination with the first aspect, the configuration information includes a CSI-RS resource set configuration, wherein the CSI-RS resource set configuration includes configurations for a set of CSI-RS resources, and wherein the set of CSI hypotheses are associated with different CSI-RS resources from the set of CSI-RS resources.

In a third aspect, alone or in combination with one or more of the first and second aspects, the configuration information includes a configuration for a CSI-RS resource, and the set of CSI hypotheses are associated with different antenna port groups.

In a fourth aspect, alone or in combination with one or more of the first through third aspects, the configuration information includes a configuration for a CSI-RS resource set for CJT, wherein the CSI-RS resource set is associated with one or more CMR groups associated with respective TRPs that are associated with the network entity, and wherein a CSI hypothesis, from the set of CSI hypotheses, includes a configuration of a CMR from each CMR group of the one or more CMR groups and a configuration of an IMR associated with the CSI hypothesis.

In a fifth aspect, alone or in combination with one or more of the first through fourth aspects, each CMR group of the one or more CMR groups includes a first quantity of CMRs that are associated with multi-TRP CSI estimations, and each CMR group of the one or more CMR groups includes the first quantity or a second quantity of CMRs that are associated with single TRP CSI estimations.

In a sixth aspect, alone or in combination with one or more of the first through fifth aspects, the CMR from each CMR group associated with the CSI hypothesis is a CMR that is associated with the multi-TRP CSI estimations.

In a seventh aspect, alone or in combination with one or more of the first through sixth aspects, the configuration information includes a configuration for a CSI-RS resource set for CJT, wherein the CSI-RS resource set is associated with a set of CMRs associated with respective TRPs that are associated with the network entity, and wherein a CSI hypothesis, from the set of CSI hypotheses, includes a configuration of one or more CMRs, from the set of CMRs, and a configuration of an IMR associated with the CSI hypothesis.

In an eighth aspect, alone or in combination with one or more of the first through seventh aspects, a single CMR, from the set of CMRs, is associated with a single TRP.

In a ninth aspect, alone or in combination with one or more of the first through eighth aspects, the configuration information includes an indication of one or more CMRs, from the set of CMRs, that are included in respective CSI hypotheses from the set of CSI hypotheses.

In a tenth aspect, alone or in combination with one or more of the first through ninth aspects, the indication includes a bitmap.

In an eleventh aspect, alone or in combination with one or more of the first through tenth aspects, the configuration information includes a configuration for a CSI-RS resource set for CJT, wherein the CSI-RS resource set is associated with a set of CMRs associated with different quantities of antenna ports, and wherein a CSI hypothesis, from the set of CSI hypotheses, includes a configuration of a CMR, from the set of CMRs, and a configuration of an IMR associated with the CSI hypothesis.

In a twelfth aspect, alone or in combination with one or more of the first through eleventh aspects, a first CSI hypothesis, from the set of CSI hypotheses, includes a first CMR, from the set of CMRs, associated with a first quantity of antenna ports and a first IMR, and a second CSI hypothesis, from the set of CSI hypotheses, includes a second CMR, from the set of CMRs, associated with a second quantity of antenna ports and a second IMR.

In a thirteenth aspect, alone or in combination with one or more of the first through twelfth aspects, a first CSI hypothesis, from the set of CSI hypotheses, includes a first CMR, from the set of CMRs, associated with a first quantity of antenna ports and a first IMR, and a second CSI hypothesis, from the set of CSI hypotheses, includes the first CMR and a second IMR.

In a fourteenth aspect, alone or in combination with one or more of the first through thirteenth aspects, the configuration information includes a configuration for a CSI-RS resource as a CMR for CJT, wherein the CSI-RS resource is associated with a set of antenna port groups, wherein an antenna port group, from the set of antenna port groups, is associated with a TRP from multiple TRPs associated with the network entity, and wherein a CSI hypothesis, from the set of CSI hypotheses, includes one or more antenna port groups, from the set of antenna port groups, and a configuration of an IMR associated with the CSI hypothesis.

In a fifteenth aspect, alone or in combination with one or more of the first through fourteenth aspects, the configuration information includes an indication of the one or more antenna port groups, from the set of antenna port groups, that are associated with the CSI hypothesis.

In a sixteenth aspect, alone or in combination with one or more of the first through fifteenth aspects, the indication includes a bitmap.

In a seventeenth aspect, alone or in combination with one or more of the first through sixteenth aspects, the configuration information indicates that the CSI-RS resource is associated with multiple IMRs including the IMR.

In an eighteenth aspect, alone or in combination with one or more of the first through seventeenth aspects, the configuration information includes a configuration for a CSI-RS resource set, wherein the CSI-RS resource set is associated with a set of CMR groups, each CMR group from the set of CMR groups being associated with respective TRPs that are associated with the network entity, wherein the CSI-RS resource set is associated with one or more CJT groups, each CJT group from the one or more CJT groups including one or more CMR groups from the set of CMR groups, wherein a first CSI hypothesis, from the set of CSI hypotheses associated with CJT CSI estimations, includes one or more CMRs from different CMR groups included in a same CJT group, and wherein a second CSI hypothesis, that is associated with non-CJT CSI estimations, includes one or more CMRs from different CJT groups.

In a nineteenth aspect, alone or in combination with one or more of the first through eighteenth aspects, the configuration information includes a configuration for a CSI-RS resource set, wherein the CSI-RS resource set is associated with a set of CJT CMR groups, each CJT CMR group from the set of CJT CMR groups being associated with one or more TRPs that are associated with the network entity, wherein each CJT CMR group is associated with a set of CMRs associated different quantities of antenna ports, wherein a first CSI hypothesis, from the set of CSI hypotheses associated with CJT CSI estimations, includes a CMR from a CJT CMR group from the set of CJT CMR groups, and wherein a second CSI hypothesis, that is associated with non-CJT CSI estimations, includes a first CMR from a first CJT CMR group and a second CMR from a second CJT CMR group.

In a twentieth aspect, alone or in combination with one or more of the first through nineteenth aspects, process 1500 includes receiving, from the network entity, a TRP configuration, wherein TRPs indicated by the TRP configuration are based at least in part on the one or more CRIs indicated in the CSI report.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network entity, in accordance with the present disclosure. Example process 1600 is an example where the network entity (e.g., the network entity 110) performs operations associated with CSI hypotheses configuration for CJT scenarios.

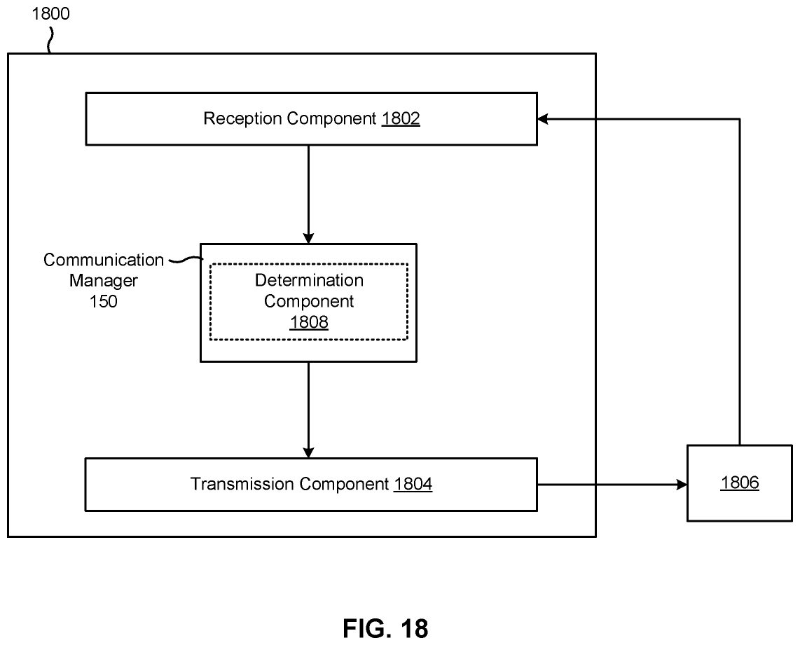

As shown in FIG. 16, in some aspects, process 1600 may include transmitting configuration information intended for a UE indicating a set of CSI hypotheses associated with CJT CSI estimations (block 1610). For example, the network entity (e.g., using communication manager 150 and/or transmission component 1804, depicted in FIG. 18) may transmit configuration information intended for a UE indicating a set of CSI hypotheses associated with CJT CSI estimations, as described above, for example, with reference to FIGS. 8, 9, 10, 11, 12, 13, and/or 14.

As further shown in FIG. 16, in some aspects, process 1600 may include receiving a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses (block 1620). For example, the network entity (e.g., using communication manager 150 and/or reception component 1802, depicted in FIG. 18) may receive a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses, as described above, for example, with reference to FIGS. 8, 9, 10, 11, 12, 13, and/or 14.

Process 1600 may include additional aspects, such as any single aspect or any combination of aspects described below and/or in connection with one or more other processes described elsewhere herein.

In a first aspect, process 1600 includes transmitting a TRP configuration intended for the UE, wherein TRPs indicated by the TRP configuration are based at least in part on the one or more CRIs indicated in the CSI report.

In a second aspect, alone or in combination with the first aspect, a CSI hypothesis, from the set of CSI hypotheses, includes a configuration of at least one of one or more CMRs, or one or more IMRs associated with the one or more CMRs.

In a third aspect, alone or in combination with one or more of the first and second aspects, the configuration information includes a CSI-RS resource set configuration, wherein the CSI-RS resource set configuration includes configurations for a set of CSI-RS resources, and wherein the set of CSI hypotheses are associated with different CSI-RS resources from the set of CSI-RS resources.

In a fourth aspect, alone or in combination with one or more of the first through third aspects, the configuration information includes a configuration for a CSI-RS resource, and the set of CSI hypotheses are associated with different antenna port groups.

In a fifth aspect, alone or in combination with one or more of the first through fourth aspects, the configuration information includes a configuration for a CSI-RS resource set for CJT, wherein the CSI-RS resource set is associated with one or more CMR groups associated with respective TRPs that are associated with the network entity, and wherein a CSI hypothesis, from the set of CSI hypotheses, includes a configuration of a CMR from each CMR group of the one or more CMR groups and a configuration of an IMR associated with the CSI hypothesis.

In a sixth aspect, alone or in combination with one or more of the first through fifth aspects, each CMR group of the one or more CMR groups includes a first quantity of CMRs that are associated with multi-TRP CSI estimations, and each CMR group of the one or more CMR groups includes the first quantity or a second quantity of CMRs that are associated with single TRP CSI estimations.

In a seventh aspect, alone or in combination with one or more of the first through sixth aspects, the CMR from each CMR group associated with the CSI hypothesis is a CMR that is associated with the multi-TRP CSI estimations.

In an eighth aspect, alone or in combination with one or more of the first through seventh aspects, the configuration information includes a configuration for a CSI-RS resource set for CJT, wherein the CSI-RS resource set is associated with a set of CMRs associated with respective TRPs that are associated with the network entity, and wherein a CSI hypothesis, from the set of CSI hypotheses, includes a configuration of one or more CMRs, from the set of CMRs, and a configuration of an IMR associated with the CSI hypothesis.

In a ninth aspect, alone or in combination with one or more of the first through eighth aspects, a single CMR, from the set of CMRs, is associated with a single TRP.

In a tenth aspect, alone or in combination with one or more of the first through ninth aspects, the configuration information includes an indication of one or more CMRs, from the set of CMRs, that are included in respective CSI hypotheses from the set of CSI hypotheses.

In an eleventh aspect, alone or in combination with one or more of the first through tenth aspects, the indication includes a bitmap.

In a twelfth aspect, alone or in combination with one or more of the first through eleventh aspects, the configuration information includes a configuration for a CSI-RS resource set for CJT, wherein the CSI-RS resource set is associated with a set of CMRs associated different quantities of antenna ports, and wherein a CSI hypothesis, from the set of CSI hypotheses, includes a configuration of a CMR, from the set of CMRs, and a configuration of an IMR associated with the CSI hypothesis.

In a thirteenth aspect, alone or in combination with one or more of the first through twelfth aspects, a first CSI hypothesis, from the set of CSI hypotheses, includes a first CMR, from the set of CMRs, associated with a first quantity of antenna ports and a first IMR, and a second CSI hypothesis, from the set of CSI hypotheses, includes a second CMR, from the set of CMRs, associated with a second quantity of antenna ports and a second IMR.

In a fourteenth aspect, alone or in combination with one or more of the first through thirteenth aspects, a first CSI hypothesis, from the set of CSI hypotheses, includes a first CMR, from the set of CMRs, associated with a first quantity of antenna ports and a first IMR, and a second CSI hypothesis, from the set of CSI hypotheses, includes the first CMR and a second IMR.

In a fifteenth aspect, alone or in combination with one or more of the first through fourteenth aspects, the configuration information includes a configuration for a CSI-RS resource as a CMR for CJT, wherein the CSI-RS resource is associated with a set of antenna port groups, wherein an antenna port group, from the set of antenna port groups, is associated with a TRP from multiple TRPs associated with the network entity, and wherein a CSI hypothesis, from the set of CSI hypotheses, includes one or more antenna port groups, from the set of antenna port groups, and a configuration of an IMR associated with the CSI hypothesis.

In a sixteenth aspect, alone or in combination with one or more of the first through fifteenth aspects, the configuration information includes an indication of the one or more antenna port groups, from the set of antenna port groups, that are associated with the CSI hypothesis.

In a seventeenth aspect, alone or in combination with one or more of the first through sixteenth aspects, the indication includes a bitmap.

In an eighteenth aspect, alone or in combination with one or more of the first through seventeenth aspects, the configuration information indicates that the CSI-RS resource is associated with multiple IMRs including the IMR.

In a nineteenth aspect, alone or in combination with one or more of the first through eighteenth aspects, the configuration information includes a configuration for a CSI-RS resource set, wherein the CSI-RS resource set is associated with a set of CMR groups, each CMR group from the set of CMR groups being associated with respective TRPs that are associated with the network entity, wherein the CSI-RS resource set is associated with one or more CJT groups, each CJT group from the one or more CJT groups including one or more CMR groups from the set of CMR groups, wherein a first CSI hypothesis, from the set of CSI hypotheses associated with CJT CSI estimations, includes one or more CMRs from different CMR groups included in a same CJT group, and wherein a second CSI hypothesis, that is associated with non-CJT CSI estimations, includes one or more CMRs from different CJT groups.

In a twentieth aspect, alone or in combination with one or more of the first through nineteenth aspects, the configuration information includes a configuration for a CSI-RS resource set, wherein the CSI-RS resource set is associated with a set of CJT CMR groups, each CJT CMR group from the set of CJT CMR groups being associated with one or more TRPs that are associated with the network entity, wherein each CJT CMR group is associated with a set of CMRs associated different quantities of antenna ports, wherein a first CSI hypothesis, from the set of CSI hypotheses associated with CJT CSI estimations, includes a CMR from a CJT CMR group from the set of CJT CMR groups, and wherein a second CSI hypothesis, that is associated with non-CJT CSI estimations, includes a first CMR from a first CJT CMR group and a second CMR from a second CJT CMR group.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication, in accordance with the present disclosure. The apparatus 1700 may be a UE, or a UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, a network entity, or another wireless communication device) using the reception component 1702 and the transmission component 1704. As further shown, the apparatus 1700 may include the communication manager 140. The communication manager 140 may include one or more of a measurement component 1708, and/or a determination component 1710, among other examples.

In some aspects, the apparatus 1700 may be configured to perform one or more operations described herein in connection with FIGS. 8-14. Additionally, or alternatively, the apparatus 1700 may be configured to perform one or more processes described herein, such as process 1500 of FIG. 15, or a combination thereof. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the UE described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the UE described in connection with FIG. 2. In some aspects, the transmission component 1704 may be co-located with the reception component 1702 in a transceiver.

The reception component 1702 may receive, from a network entity, configuration information indicating a set of CSI hypotheses associated with CJT CSI estimations. The transmission component 1704 may transmit, to the network entity, a CSI report indicating one or more CRIs associated with one or more CSI hypotheses of the set of CSI hypotheses, wherein each CRI of the one or more CRIs is associated with a respective CSI hypothesis from the one or more CSI hypotheses.

The reception component 1702 may receive, from the network entity, a TRP configuration, wherein TRPs indicated by the TRP configuration are based at least in part on the one or more CRIs indicated in the CSI report.

The measurement component 1708 may perform one or more measurements in accordance with the set of CSI hypotheses. The determination component 1710 may determine the one or more CRIs based at least in part on the one or more measurements.

The quantity and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication, in accordance with the present disclosure. The apparatus 1800 may be a network entity, or a network entity may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 150. The communication manager 150 may include a determination component 1808, among other examples.

In some aspects, the apparatus 1800 may be configured to perform one or more operations described herein in connection with FIGS. 8-14. Additionally, or alternatively, the apparatus 1800 may be configured to perform one or more processes described herein, such as process 1600 of FIG. 16, or a combination thereof. In some aspects, the apparatus 1800 and/or one or more components shown in FIG. 18 may include one or more components of the network entity described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the network entity described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the network entity described in connection with FIG. 2. In some aspects, the transmission component 1804 may be co-located with the reception component 1802 in a transceiver.

The transmission component 1804 may transmit configuration information intended for a UE indicating a set of CSI hypotheses associated with CJT CSI estimations. The reception component 1802 may receive a CSI report associated with the UE indicating one or more CRIs associated with one or more CSI hypotheses from the set of CSI hypotheses, wherein each CRI of the one or more CRIs is associated with a respective CSI hypothesis from the one or more CSI hypotheses.

The transmission component 1804 may transmit a TRP configuration intended for the UE, wherein TRPs indicated by the TRP configuration are based at least in part on the one or more CRIs indicated in the CSI report. The determination component 1808 may determine the TRP configuration based at least in part on the CSI report.

The quantity and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by a user equipment (UE), comprising: receiving, from a network entity, configuration information indicating a set of channel state information (CSI) hypotheses associated with coherent joint transmission (CJT) CSI estimations; and transmitting, to the network entity, a CSI report indicating one or more CSI reference signal (CSI-RS) resource indicators (CRIs) associated with one or more CSI hypotheses of the set of CSI hypotheses, wherein each CRI of the one or more CRIs is associated with a respective CSI hypothesis from the one or more CSI hypotheses.

Aspect 2: The method of Aspect 1, wherein a CSI hypothesis, from the set of CSI hypotheses, includes a configuration of at least one of: one or more channel measurement resources (CMRs), or one or more interference measurement resources (IMRs) associated with the one or more CMRs.

Aspect 3: The method of any of Aspects 1-2, wherein the configuration information includes a CSI-RS resource set configuration, wherein the CSI-RS resource set configuration includes configurations for a set of CSI-RS resources, and wherein the set of CSI hypotheses are associated with different CSI-RS resources from the set of CSI-RS resources.

Aspect 4: The method of any of Aspects 1-3, wherein the configuration information includes a configuration for a CSI-RS resource, and wherein the set of CSI hypotheses are associated with different antenna port groups.

Aspect 5: The method of any of Aspects 1-4, wherein the configuration information includes a configuration for a CSI-RS resource set for CJT, wherein the CSI-RS resource set is associated with one or more channel measurement resource (CMR) groups associated with respective transmission reception points (TRPs) that are associated with the network entity, and wherein a CSI hypothesis, from the set of CSI hypotheses, includes a configuration of a CMR from each CMR group of the one or more CMR groups and a configuration of an interference measurement resource (IMR) associated with the CSI hypothesis.

Aspect 6: The method of Aspect 5, wherein each CMR group of the one or more CMR groups includes a first quantity of CMRs that are associated with multiple TRP (multi-TRP) CSI estimations, and wherein each CMR group of the one or more CMR groups includes the first quantity or a second quantity of CMRs that are associated with single TRP CSI estimations.

Aspect 7: The method of Aspect 6, wherein the CMR from each CMR group associated with the CSI hypothesis is a CMR that is associated with the multi-TRP CSI estimations.

Aspect 8: The method of any of Aspects 1-4, wherein the configuration information includes a configuration for a CSI-RS resource set for CJT, wherein the CSI-RS resource set is associated with a set of channel measurement resources (CMRs) associated with respective transmission reception points (TRPs) that are associated with the network entity, and wherein a CSI hypothesis, from the set of CSI hypotheses, includes a configuration of one or more CMRs, from the set of CMRs, and a configuration of an interference measurement resource (IMR) associated with the CSI hypothesis.

Aspect 9: The method of Aspect 8, wherein a single CMR, from the set of CMRs, is associated with a single TRP.

Aspect 10: The method of any of Aspects 8-9, wherein the configuration information includes an indication of one or more CMRs, from the set of CMRs, that are included in respective CSI hypotheses from the set of CSI hypotheses.

Aspect 11: The method of Aspect 10, wherein the indication includes a bitmap.

Aspect 12: The method of any of Aspects 1-4, wherein the configuration information includes a configuration for a CSI-RS resource set for CJT, wherein the CSI-RS resource set is associated with a set of channel measurement resources (CMRs) associated with different quantities of antenna ports, and wherein a CSI hypothesis, from the set of CSI hypotheses, includes a configuration of a CMR, from the set of CMRs, and a configuration of an interference measurement resource (IMR) associated with the CSI hypothesis.

Aspect 13: The method of Aspect 12, wherein a first CSI hypothesis, from the set of CSI hypotheses, includes a first CMR, from the set of CMRs, associated with a first quantity of antenna ports and a first IMR, and wherein a second CSI hypothesis, from the set of CSI hypotheses, includes a second CMR, from the set of CMRs, associated with a second quantity of antenna ports and a second IMR.

Aspect 14: The method of any of Aspects 12-13, wherein a first CSI hypothesis, from the set of CSI hypotheses, includes a first CMR, from the set of CMRs, associated with a first quantity of antenna ports and a first IMR, and wherein a second CSI hypothesis, from the set of CSI hypotheses, includes the first CMR and a second IMR.

Aspect 15: The method of any of Aspects 1-4, wherein the configuration information includes a configuration for a CSI-RS resource as a channel measurement resource (CMR) for CJT, wherein the CSI-RS resource is associated with a set of antenna port groups, wherein an antenna port group, from the set of antenna port groups, is associated with a transmission reception point (TRP) from multiple TRPs associated with the network entity, and wherein a CSI hypothesis, from the set of CSI hypotheses, includes one or more antenna port groups, from the set of antenna port groups, and a configuration of an interference measurement resource (IMR) associated with the CSI hypothesis.

Aspect 16: The method of Aspect 15, wherein the configuration information includes an indication of the one or more antenna port groups, from the set of antenna port groups, that are associated with the CSI hypothesis.

Aspect 17: The method of Aspect 16, wherein the indication includes a bitmap.

Aspect 18: The method of any of Aspects 15-17, wherein the configuration information indicates that the CSI-RS resource is associated with multiple IMRs including the IMR.

Aspect 19: The method of any of Aspects 1-18, wherein the configuration information includes a configuration for a CSI-RS resource set, wherein the CSI-RS resource set is associated with a set of channel measurement resource (CMR) groups, each CMR group from the set of CMR groups being associated with respective transmission reception points (TRPs) that are associated with the network entity, wherein the CSI-RS resource set is associated with one or more CJT groups, each CJT group from the one or more CJT groups including one or more CMR groups from the set of CMR groups, wherein a first CSI hypothesis, from the set of CSI hypotheses associated with CJT CSI estimations, includes one or more CMRs from different CMR groups included in a same CJT group, and wherein a second CSI hypothesis, that is associated with non-CJT CSI estimations, includes one or more CMRs from different CJT groups.

Aspect 20: The method of any of Aspects 1-18, wherein the configuration information includes a configuration for a CSI-RS resource set, wherein the CSI-RS resource set is associated with a set of CJT channel measurement resource (CMR) groups, each CJT CMR group from the set of CJT CMR groups being associated with one or more transmission reception points (TRPs) that are associated with the network entity, wherein each CJT CMR group is associated with a set of CMRs associated different quantities of antenna ports, wherein a first CSI hypothesis, from the set of CSI hypotheses associated with CJT CSI estimations, includes a CMR from a CJT CMR group from the set of CJT CMR groups, and wherein a second CSI hypothesis, that is associated with non-CJT CSI estimations, includes a first CMR from a first CJT CMR group and a second CMR from a second CJT CMR group.

Aspect 21: The method of any of Aspects 1-20, further comprising: receiving, from the network entity, a transmission reception point (TRP) configuration, wherein TRPs indicated by the TRP configuration are based at least in part on the one or more CRIs indicated in the CSI report.

Aspect 22: A method of wireless communication performed by a network entity, comprising: transmitting configuration information intended for a user equipment (UE) indicating a set of channel state information (CSI) hypotheses associated with coherent joint transmission (CJT) CSI estimations; and receiving a CSI report associated with the UE indicating one or more CSI reference signal (CSI-RS) resource indicators (CRIs) associated with one or more CSI hypotheses from the set of CSI hypotheses, wherein each CRI of the one or more CRIs is associated with a respective CSI hypothesis from the one or more CSI hypotheses.

Aspect 23: The method of Aspect 22, further comprising: transmitting a transmission reception point (TRP) configuration intended for the UE, wherein TRPs indicated by the TRP configuration are based at least in part on the one or more CRIs indicated in the CSI report.

Aspect 24: The method of any of Aspects 22-23, wherein a CSI hypothesis, from the set of CSI hypotheses, includes a configuration of at least one of: one or more channel measurement resources (CMRs), or one or more interference measurement resources (IMRs) associated with the one or more CMRs.

Aspect 25: The method of any of Aspects 22-24, wherein the configuration information includes a CSI-RS resource set configuration, wherein the CSI-RS resource set configuration includes configurations for a set of CSI-RS resources, and wherein the set of CSI hypotheses are associated with different CSI-RS resources from the set of CSI-RS resources.

Aspect 26: The method of any of Aspects 22-25, wherein the configuration information includes a configuration for a CSI-RS resource, and wherein the set of CSI hypotheses are associated with different antenna port groups.

Aspect 27: The method of any of Aspects 22-26, wherein the configuration information includes a configuration for a CSI-RS resource set for CJT, wherein the CSI-RS resource set is associated with one or more channel measurement resource (CMR) groups associated with respective transmission reception points (TRPs) that are associated with the network entity, and wherein a CSI hypothesis, from the set of CSI hypotheses, includes a configuration of a CMR from each CMR group of the one or more CMR groups and a configuration of an interference measurement resource (IMR) associated with the CSI hypothesis.

Aspect 28: The method of Aspect 27, wherein each CMR group of the one or more CMR groups includes a first quantity of CMRs that are associated with multiple TRP (multi-TRP) CSI estimations, and wherein each CMR group of the one or more CMR groups includes the first quantity or a second quantity of CMRs that are associated with single TRP CSI estimations.

Aspect 29: The method of Aspect 28, wherein the CMR from each CMR group associated with the CSI hypothesis is a CMR that is associated with the multi-TRP CSI estimations.

Aspect 30: The method of any of Aspects 22-26, wherein the configuration information includes a configuration for a CSI-RS resource set for CJT, wherein the CSI-RS resource set is associated with a set of channel measurement resources (CMRs) associated with respective transmission reception points (TRPs) that are associated with the network entity, and wherein a CSI hypothesis, from the set of CSI hypotheses, includes a configuration of one or more CMRs, from the set of CMRs, and a configuration of an interference measurement resource (IMR) associated with the CSI hypothesis.

Aspect 31: The method of Aspect 30, wherein a single CMR, from the set of CMRs, is associated with a single TRP.

Aspect 32: The method of any of Aspects 30-31, wherein the configuration information includes an indication of one or more CMRs, from the set of CMRs, that are included in respective CSI hypotheses from the set of CSI hypotheses.

Aspect 33: The method of Aspect 32, wherein the indication includes a bitmap.

Aspect 34: The method of any of Aspects 22-26, wherein the configuration information includes a configuration for a CSI-RS resource set for CJT, wherein the CSI-RS resource set is associated with a set of channel measurement resources (CMRs) associated different quantities of antenna ports, and wherein a CSI hypothesis, from the set of CSI hypotheses, includes a configuration of a CMR, from the set of CMRs, and a configuration of an interference measurement resource (IMR) associated with the CSI hypothesis.

Aspect 35: The method of Aspect 34, wherein a first CSI hypothesis, from the set of CSI hypotheses, includes a first CMR, from the set of CMRs, associated with a first quantity of antenna ports and a first IMR, and wherein a second CSI hypothesis, from the set of CSI hypotheses, includes a second CMR, from the set of CMRs, associated with a second quantity of antenna ports and a second IMR.

Aspect 36: The method of any of Aspects 34-35, wherein a first CSI hypothesis, from the set of CSI hypotheses, includes a first CMR, from the set of CMRs, associated with a first quantity of antenna ports and a first IMR, and wherein a second CSI hypothesis, from the set of CSI hypotheses, includes the first CMR and a second IMR.

Aspect 37: The method of any of Aspects 22-26, wherein the configuration information includes a configuration for a CSI-RS resource as a channel measurement resource (CMR) for CJT, wherein the CSI-RS resource is associated with a set of antenna port groups, wherein an antenna port group, from the set of antenna port groups, is associated with a transmission reception point (TRP) from multiple TRPs associated with the network entity, and wherein a CSI hypothesis, from the set of CSI hypotheses, includes one or more antenna port groups, from the set of antenna port groups, and a configuration of an interference measurement resource (IMR) associated with the CSI hypothesis.

Aspect 38: The method of Aspect 37, wherein the configuration information includes an indication of the one or more antenna port groups, from the set of antenna port groups, that are associated with the CSI hypothesis.

Aspect 39: The method of Aspect 38, wherein the indication includes a bitmap.

Aspect 40: The method of any of Aspects 37-39, wherein the configuration information indicates that the CSI-RS resource is associated with multiple IMRs including the IMR.

Aspect 41: The method of any of Aspects 22-40, wherein the configuration information includes a configuration for a CSI-RS resource set, wherein the CSI-RS resource set is associated with a set of channel measurement resource (CMR) groups, each CMR group from the set of CMR groups being associated with respective transmission reception points (TRPs) that are associated with the network entity, wherein the CSI-RS resource set is associated with one or more CJT groups, each CJT group from the one or more CJT groups including one or more CMR groups from the set of CMR groups, wherein a first CSI hypothesis, from the set of CSI hypotheses associated with CJT CSI estimations, includes one or more CMRs from different CMR groups included in a same CJT group, and wherein a second CSI hypothesis, that is associated with non-CJT CSI estimations, includes one or more CMRs from different CJT groups.

Aspect 42: The method of any of Aspects 22-40, wherein the configuration information includes a configuration for a CSI-RS resource set, wherein the CSI-RS resource set is associated with a set of CJT channel measurement resource (CMR) groups, each CJT CMR group from the set of CJT CMR groups being associated with one or more transmission reception points (TRPs) that are associated with the network entity, wherein each CJT CMR group is associated with a set of CMRs associated different quantities of antenna ports, wherein a first CSI hypothesis, from the set of CSI hypotheses associated with CJT CSI estimations, includes a CMR from a CJT CMR group from the set of CJT CMR groups, and wherein a second CSI hypothesis, that is associated with non-CJT CSI estimations, includes a first CMR from a first CJT CMR group and a second CMR from a second CJT CMR group.

Aspect 43: An apparatus for wireless communication at a device, comprising a processor; memory coupled with the processor; and instructions stored in the memory and executable by the processor to cause the apparatus to perform the method of one or more of Aspects 1-21.

Aspect 44: A device for wireless communication, comprising a memory and one or more processors coupled to the memory, the one or more processors configured to perform the method of one or more of Aspects 1-21.

Aspect 45: An apparatus for wireless communication, comprising at least one means for performing the method of one or more of Aspects 1-21.

Aspect 46: A non-transitory computer-readable medium storing code for wireless communication, the code comprising instructions executable by a processor to perform the method of one or more of Aspects 1-21.

Aspect 47: A non-transitory computer-readable medium storing a set of instructions for wireless communication, the set of instructions comprising one or more instructions that, when executed by one or more processors of a device, cause the device to perform the method of one or more of Aspects 1-21.

Aspect 48: An apparatus for wireless communication at a device, comprising a processor; memory coupled with the processor; and instructions stored in the memory and executable by the processor to cause the apparatus to perform the method of one or more of Aspects 22-42.

Aspect 49: A device for wireless communication, comprising a memory and one or more processors coupled to the memory, the one or more processors configured to perform the method of one or more of Aspects 22-42.

Aspect 50: An apparatus for wireless communication, comprising at least one means for performing the method of one or more of Aspects 22-42.

Aspect 51: A non-transitory computer-readable medium storing code for wireless communication, the code comprising instructions executable by a processor to perform the method of one or more of Aspects 22-42.

Aspect 52: A non-transitory computer-readable medium storing a set of instructions for wireless communication, the set of instructions comprising one or more instructions that, when executed by one or more processors of a device, cause the device to perform the method of one or more of Aspects 22-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network entity, configuration information indicating a set of channel state information (CSI) hypotheses associated with coherent joint transmission (CJT) CSI estimations; and
transmit, to the network entity, a CSI report indicating one or more CSI reference signal (CSI-RS) resource indicators (CRIs) associated with one or more CSI hypotheses of the set of CSI hypotheses, wherein each CRI of the one or more CRIs is associated with a respective CSI hypothesis from the one or more CSI hypotheses.

2. The UE of claim 1, wherein the configuration information includes a configuration for a CSI-RS resource set for CJT,
wherein the CSI-RS resource set is associated with one or more channel measurement resource (CMR) groups associated with respective transmission reception points (TRPs) that are associated with the network entity, and
wherein a CSI hypothesis, from the set of CSI hypotheses, includes a configuration of a CMR from each CMR group of the one or more CMR groups and a configuration of an interference measurement resource (IMR) associated with the CSI hypothesis.

3. The UE of claim 2, wherein each CMR group of the one or more CMR groups includes a first quantity of CMRs that are associated with multiple TRP (multi-TRP) CSI estimations, and
wherein each CMR group of the one or more CMR groups includes the first quantity or a second quantity of CMRs that are associated with single TRP CSI estimations.

4. The UE of claim 1, wherein the configuration information includes a configuration for a CSI-RS resource set for CJT,
wherein the CSI-RS resource set is associated with a set of channel measurement resources (CMRs) associated with respective transmission reception points (TRPs) that are associated with the network entity, and
wherein a CSI hypothesis, from the set of CSI hypotheses, includes a configuration of one or more CMRs, from the set of CMRs, and a configuration of an interference measurement resource (IMR) associated with the CSI hypothesis.

5. The UE of claim 4, wherein the configuration information includes an indication of one or more CMRs, from the set of CMRs, that are included in respective CSI hypotheses from the set of CSI hypotheses, and wherein the indication includes a bitmap.

6. The UE of claim 1, wherein the configuration information includes a configuration for a CSI-RS resource set for CJT,
wherein the CSI-RS resource set is associated with a set of channel measurement resources (CMRs) associated with different quantities of antenna ports, and
wherein a CSI hypothesis, from the set of CSI hypotheses, includes a configuration of a CMR, from the set of CMRs, and a configuration of an interference measurement resource (IMR) associated with the CSI hypothesis.

7. The UE of claim 6, wherein a first CSI hypothesis, from the set of CSI hypotheses, includes a first CMR, from the set of CMRs, associated with a first quantity of antenna ports and a first IMR, and
wherein a second CSI hypothesis, from the set of CSI hypotheses, includes the first CMR and a second IMR.

8. The UE of claim 1, wherein the configuration information includes a configuration for a CSI-RS resource as a channel measurement resource (CMR) for CJT,
wherein the CSI-RS resource is associated with a set of antenna port groups,
wherein an antenna port group, from the set of antenna port groups, is associated with a transmission reception point (TRP) from multiple TRPs associated with the network entity, and
wherein a CSI hypothesis, from the set of CSI hypotheses, includes one or more antenna port groups, from the set of antenna port groups, and a configuration of an interference measurement resource (IMR) associated with the CSI hypothesis.

9. The UE of claim 8, wherein the configuration information includes an indication of the one or more antenna port groups, from the set of antenna port groups, that are associated with the CSI hypothesis.

10. The UE of claim 8, wherein the configuration information indicates that the CSI-RS resource is associated with multiple IMRs including the IMR.

11. The UE of claim 1, wherein the configuration information includes a configuration for a CSI-RS resource set,
wherein the CSI-RS resource set is associated with a set of channel measurement resource (CMR) groups, each CMR group from the set of CMR groups being associated with respective transmission reception points (TRPs) that are associated with the network entity,
wherein the CSI-RS resource set is associated with one or more CJT groups, each CJT group from the one or more CJT groups including one or more CMR groups from the set of CMR groups,
wherein a first CSI hypothesis, from the set of CSI hypotheses associated with CJT CSI estimations, includes one or more CMRs from different CMR groups included in a same CJT group, and
wherein a second CSI hypothesis, that is associated with non-CJT CSI estimations, includes one or more CMRs from different CJT groups.

12. The UE of claim 1, wherein the configuration information includes a configuration for a CSI-RS resource set,
wherein the CSI-RS resource set is associated with a set of CJT channel measurement resource (CMR) groups, each CJT CMR group from the set of CJT CMR groups being associated with one or more transmission reception points (TRPs) that are associated with the network entity,
wherein each CJT CMR group is associated with a set of CMRs associated different quantities of antenna ports,
wherein a first CSI hypothesis, from the set of CSI hypotheses associated with CJT CSI estimations, includes a CMR from a CJT CMR group from the set of CJT CMR groups, and
wherein a second CSI hypothesis, that is associated with non-CJT CSI estimations, includes a first CMR from a first CJT CMR group and a second CMR from a second CJT CMR group.

13. A network entity for wireless communication, comprising:
a memory; and
one or more processors, coupled to the memory, configured to:
transmit configuration information intended for a user equipment (UE) indicating a set of channel state information (CSI) hypotheses associated with coherent joint transmission (CJT) CSI estimations; and
receive a CSI report associated with the UE indicating one or more CSI reference signal (CSI-RS) resource indicators (CRIs) associated with one or more CSI hypotheses from the set of CSI hypotheses, wherein each CRI of the one or more CRIs is associated with a respective CSI hypothesis from the one or more CSI hypotheses.

14. The network entity of claim 13, wherein the one or more processors are further configured to:
transmit a transmission reception point (TRP) configuration intended for the UE, wherein TRPs indicated by the TRP configuration are based at least in part on the one or more CRIs indicated in the CSI report.

15. The network entity of claim 13, wherein the configuration information includes a CSI-RS resource set configuration, wherein the CSI-RS resource set configuration includes configurations for a set of CSI-RS resources, and wherein the set of CSI hypotheses are associated with different CSI-RS resources from the set of CSI-RS resources.

16. A method of wireless communication performed by a user equipment (UE), comprising:
receiving, from a network entity, configuration information indicating a set of channel state information (CSI) hypotheses associated with coherent joint transmission (CJT) CSI estimations; and
transmitting, to the network entity, a CSI report indicating one or more CSI reference signal (CSI-RS) resource indicators (CRIs) associated with one or more CSI hypotheses of the set of CSI hypotheses, wherein each CRI of the one or more CRIs is associated with a respective CSI hypothesis from the one or more CSI hypotheses.

17. The method of claim 16, wherein the configuration information includes a configuration for a CSI-RS resource set for CJT,
wherein the CSI-RS resource set is associated with one or more channel measurement resource (CMR) groups associated with respective transmission reception points (TRPs) that are associated with the network entity, and
wherein a CSI hypothesis, from the set of CSI hypotheses, includes a configuration of a CMR from each CMR group of the one or more CMR groups and a configuration of an interference measurement resource (IMR) associated with the CSI hypothesis.

18. The method of claim 17, wherein each CMR group of the one or more CMR groups includes a first quantity of CMRs that are associated with multiple TRP (multi-TRP) CSI estimations, and
wherein each CMR group of the one or more CMR groups includes the first quantity or a second quantity of CMRs that are associated with single TRP CSI estimations.

19. The method of claim 16, wherein the configuration information includes a configuration for a CSI-RS resource set for CJT,
wherein the CSI-RS resource set is associated with a set of channel measurement resources (CMRs) associated with respective transmission reception points (TRPs) that are associated with the network entity, and
wherein a CSI hypothesis, from the set of CSI hypotheses, includes a configuration of one or more CMRs, from the set of CMRs, and a configuration of an interference measurement resource (IMR) associated with the CSI hypothesis.

20. The method of claim 19, wherein the configuration information includes an indication of one or more CMRs, from the set of CMRs, that are included in respective CSI hypotheses from the set of CSI hypotheses, and wherein the indication includes a bitmap.

21. The method of claim 16, wherein the configuration information includes a configuration for a CSI-RS resource set for CJT,
wherein the CSI-RS resource set is associated with a set of channel measurement resources (CMRs) associated with different quantities of antenna ports, and
wherein a CSI hypothesis, from the set of CSI hypotheses, includes a configuration of a CMR, from the set of CMRs, and a configuration of an interference measurement resource (IMR) associated with the CSI hypothesis.

22. The method of claim 21, wherein a first CSI hypothesis, from the set of CSI hypotheses, includes a first CMR, from the set of CMRs, associated with a first quantity of antenna ports and a first IMR, and
wherein a second CSI hypothesis, from the set of CSI hypotheses, includes the first CMR and a second IMR.

23. The method of claim 16, wherein the configuration information includes a configuration for a CSI-RS resource as a channel measurement resource (CMR) for CJT,
wherein the CSI-RS resource is associated with a set of antenna port groups,
wherein an antenna port group, from the set of antenna port groups, is associated with a transmission reception point (TRP) from multiple TRPs associated with the network entity, and
wherein a CSI hypothesis, from the set of CSI hypotheses, includes one or more antenna port groups, from the set of antenna port groups, and a configuration of an interference measurement resource (IMR) associated with the CSI hypothesis.

24. The method of claim 23, wherein the configuration information includes an indication of the one or more antenna port groups, from the set of antenna port groups, that are associated with the CSI hypothesis.

25. The method of claim 23, wherein the configuration information indicates that the CSI-RS resource is associated with multiple IMRs including the IMR.

26. The method of claim 16, wherein the configuration information includes a configuration for a CSI-RS resource set,
wherein the CSI-RS resource set is associated with a set of channel measurement resource (CMR) groups, each CMR group from the set of CMR groups being associated with respective transmission reception points (TRPs) that are associated with the network entity,
wherein the CSI-RS resource set is associated with one or more CJT groups, each CJT group from the one or more CJT groups including one or more CMR groups from the set of CMR groups,
wherein a first CSI hypothesis, from the set of CSI hypotheses associated with CJT CSI estimations, includes one or more CMRs from different CMR groups included in a same CJT group, and
wherein a second CSI hypothesis, that is associated with non-CJT CSI estimations, includes one or more CMRs from different CJT groups.

27. The method of claim 16, wherein the configuration information includes a configuration for a CSI-RS resource set,
wherein the CSI-RS resource set is associated with a set of CJT channel measurement resource (CMR) groups, each CJT CMR group from the set of CJT CMR groups being associated with one or more transmission reception points (TRPs) that are associated with the network entity,
wherein each CJT CMR group is associated with a set of CMRs associated different quantities of antenna ports,
wherein a first CSI hypothesis, from the set of CSI hypotheses associated with CJT CSI estimations, includes a CMR from a CJT CMR group from the set of CJT CMR groups, and
wherein a second CSI hypothesis, that is associated with non-CJT CSI estimations, includes a first CMR from a first CJT CMR group and a second CMR from a second CJT CMR group.

28. A method of wireless communication performed by a network entity, comprising:
transmitting configuration information intended for a user equipment (UE) indicating a set of channel state information (CSI) hypotheses associated with coherent joint transmission (CJT) CSI estimations; and
receiving a CSI report associated with the UE indicating one or more CSI reference signal (CSI-RS) resource indicators (CRIs) associated with one or more CSI hypotheses from the set of CSI hypotheses, wherein each CRI of the one or more CRIs is associated with a respective CSI hypothesis from the one or more CSI hypotheses.

29. The method of claim 28, further comprising:
transmitting a transmission reception point (TRP) configuration intended for the UE, wherein TRPs indicated by the TRP configuration are based at least in part on the one or more CRIs indicated in the CSI report.

30. The method of claim 28, wherein the configuration information includes a CSI-RS resource set configuration, wherein the CSI-RS resource set configuration includes configurations for a set of CSI-RS resources, and wherein the set of CSI hypotheses are associated with different CSI-RS resources from the set of CSI-RS resources.
